(19) United States
(12) Patent Application Publication
(10) Pub. No.: US 2023/0185732 A1
(43) Pub. Date: Jun. 15, 2023

(54) TRANSPARENT ENCRYPTION

(71) Applicant: Intel Corporation, Santa Clara, CA (US)

(72) Inventors: Weigang Li, Shanghai (CN); Changzheng Wei, Shanghai (CN); John Barry, Galway (IE); Maryam Tahhan, Limerick (IE); Jonas Alexander Svennebring, Sollentuna (SE); Niall D. McDonnell, Limerick (IE); Alexander Leckey, Kilcock (IE); Patrick Fleming, Laois (IE); Christopher MacNamara, Limerick (IE); John Joseph Browne, Limerick (IE)

(73) Assignee: Intel Corporation, Santa Clara, CA (US)

(21) Appl. No.: 18/107,399

(22) Filed: Feb. 8, 2023

Related U.S. Application Data
(63) Continuation of application No. 17/041,768, filed on Sep. 25, 2020.

(51) Int. Cl. G06F 12/14; G06F 13/16; G06F 13/28; G06F 21/53; G06F 21/60; G06F 21/79

(52) U.S. Cl. CPC G06F 12/1408; G06F 13/1668; G06F 13/28; G06F 21/53; G06F 21/602; G06F 21/606; G06F 21/79; G06F 2213/0038

(57) ABSTRACT

There is disclosed a computing apparatus, including: a memory; a memory encryption controller to encrypt at least a region of the memory; and a network interface to communicatively couple the computing apparatus to a remote host; wherein the memory encryption controller is configured to send an encrypted packet decryptable via an encryption key directly from the memory to the remote host via the network interface, bypassing a network protocol stack.

### FIELD OF THE SPECIFICATION

This disclosure relates in general to the field of secure communication, and more particularly, though not exclusively, to a system and method for providing transparent encryption.

### BACKGROUND

In some modern data centers, the function of a device or appliance may not be tied to a specific, fixed hardware configuration. Rather, processing, memory, storage, and accelerator functions may in some cases be aggregated from different locations to form a virtual “composite node.” A contemporary network may include a data center hosting a large number of generic hardware server devices, contained in a server rack for example, and controlled by a hypervisor. Each hardware device may run one or more instances of a virtual device, such as a workload server or virtual desktop.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a secure communication, according to one or more examples of the present specification.

FIG. 2 is a further block diagram of a secure communication, according to one or more examples of the present specification.

FIG. 3 is a block diagram of an alternative secure communication, according to one or more examples of the present specification.

FIG. 4 is a flowchart of a method of transmitting an encrypted packet, according to one or more examples of the present specification.

FIG. 5 is a flowchart of a method of receiving an encrypted packet, according to one or more examples of the present specification.

FIG. 6 is a block diagram of a trusted execution environment (TEE), according to one or more examples of the present specification.

FIG. 7 is a block diagram of a multi-key total memory encryption (MKTME) system, according to one or more examples of the present specification.

FIG. 8 is a block diagram of a hardware platform, according to one or more examples of the present specification.

FIG. 9 is a block diagram of selected components of a data center with connectivity to a network of cloud service provider (CSP), according to one or more examples of the present application.

FIG. 10 is a block diagram of selected components of an end-user computing device, according to one or more examples of the present specification.

FIG. 11 is a block diagram of a network function virtualization (NFV) architecture, according to one or more examples of the present specification.

FIG. 12 is a block diagram of components of a computing platform, according to one or more examples of the present specification.

FIG. 13 is a block diagram of a central processing unit (CPU), according to one or more examples of the present specification.

FIG. 14 is a block diagram of rack scale design (RSD), according to one or more examples of the present specification.

FIG. 15 is a block diagram of a software-defined infrastructure (SDI) data center, according to one or more examples of the present specification.

FIG. 16 is a block diagram of a data center, according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

A contemporary computing platform, such as a hardware platform provided by Intel® or similar, may include a capability for monitoring device performance and making decisions about resource provisioning. For example, in a large data center such as may be provided by a cloud service provider (CSP), the hardware platform may include rackmounted servers with compute resources such as processors, memory, storage pools, accelerators, and other similar resources. As used herein, “cloud computing” includes network-connected computing resources and technology that enables ubiquitous (often worldwide) access to data, resources, and/or technology. Cloud resources are generally characterized by great flexibility to dynamically assign resources according to current workloads and needs. This can be accomplished, for example, via virtualization, wherein resources such as hardware, storage, and networks are provided to a virtual machine (VM) via a software abstraction layer, and/or containerization, wherein instances of network functions are provided in “containers” that are separated from one another, but that share underlying operating system, memory, and driver resources.

Secure network communication is a critical component of a modern communication infrastructure. While in the past it was common for communications to occur over unsecured channels such as hypertext transport protocol (HTTP), the proliferation of malware, bad actors, government surveillance, state-sponsored cyber terrorism, and other threats has driven the Internet and the World Wide Web to increasingly use more secure communication channels such as hypertext transport protocol secure (HTTPS), which uses an encryption protocol such as secure socket layer (SSL) or transport layer security (TLS) to encrypt point-to-point communications, and thus ensure that transmissions cannot be snooped or spied on.

Secure communications can also be an important factor within a data center. For example, a data center may include a number of disparate tenants operating VMs that coexist and communicate over common hardware interfaces.

In embodiments of the present disclosure, a tenant is a group of users sharing common access privileges to a software instance hosted in a public or private, cloud-based computer network. In a multitenant cloud environment, each tenant's data is isolated from and invisible to each other tenant.

Further, as disclosed herein, a VM is an isolated partition within a computing device that allows usage of an operating system and other applications, independent of other programs on the device in which it is contained. VMs, containers, and similar may be generically referred to as “guest” systems.

As used in the present specification, a data center is a facility (as within an organization or enterprise, by nonlimiting example) that provides the physical or virtual infrastructure for information technology (IT) server and networking components. These components may provide storage, organization, management, processing, and dissemination of data in either a centralized, aggregated manner, or in a disaggregated manner by way of communicatively connecting resources in disparate locations.

In a multitenant data center, tenants may demand that their data and communications are secured from other tenants within the data center. Thus, to provide this security, communications within the data center may also be encrypted.

Traditional secure pocket processing between two hosts (which may be physically remote hosts, or which may be only conceptually remote hosts, in the sense that they may reside on the same hardware but exist in separate VMs) relies on secure network protocols such as Internet protocol security (IPsec), transport layer security/secure socket layer (TLS/SSL), and others. These require packet payloads in transit to be copied from application memory to a protocol stack. The packets are then encrypted within the protocol stack, which may occur either in software, or may be offloaded to a high speed hardware accelerator, such as a field-programmable gate array (FPGA) in a data center. The encrypted packet is then transmitted via a network interface, network device, or other network controller to the remote host. At the remote host, the packet is again decrypted within the protocol stack, either in software or via a hardware accelerator. The packet can then be processed on the remote host.

However, some contemporary computing hardware platforms include memory controllers that provide total memory encryption (TME). With a TME controller, the entire volatile memory of the hardware platform can be encrypted. Alternatively, at least a portion of the volatile memory, such as specific hardware pages, can be encrypted. TME can be supported by instruction sets, such as those provided in Intel® Xeon processors or others, that provide full encryption of dynamic random access memory (DRAM) and nonvolatile random access memory (NVRAM) with a single encryption key. A further extension of the TME protocol is multi-key total memory encryption (MKTME), which supports multiple encryption keys, which can be used to encrypt different memory pages. With MKTME, different encryption keys can be owned by specific VMs or other guests within the hardware platform, so that the various guests can manage encryption of their own memory pages without those pages being visible to other guests on the same system.

When TME, MKTME, or other memory encryption technologies are present on a system, a packet to be transferred from a first host to a remote host may first be decrypted within the memory controller, then copied to the network protocol stack for transmission to the remote host. The network protocol stack may then again encrypt the packet with a protocol session key. The host then sends the packet to the remote host, which decrypts the packet, and processes the packet internally. This involves multiple memory copies and encryption/decryption operations. These multiple operations may be particularly superfluous in the case that both hosts support TME, in which case encryption and decryption at the protocol stack becomes a bottleneck, because packets have to be decrypted then re-encrypted for transmission. Even in cases where encryption and decryption are handled by very fast hardware accelerators, these extra encryption and decryption operations are at best unnecessary and consume extra power and compute resources.

Embodiments of the present specification improve on this infrastructure by recognizing that when two devices that both support native memory encryption with a shared encryption key are sending data back and forth, there is no need to encrypt those data at the protocol stack. Rather, a protocol such as remote direct memory access (RDMA) may be used to bypass the secure protocol stack and leverage MKTME or similar to provide transparent encryption within the memory controller instead of within the protocol stack.

This improves server performance per watt, and lowers the core and/or crypto accelerator cycle cost and transfer latency. Secure network communications are also accelerated. Note that these types of secure network communications (e.g., peer to peer) are common not only in the World Wide Web, but also in data centers, network function virtualization, software-defined networking, telecommunications, cloud applications, NFV Long Term Evolution (LTE) wireless/5G gateways, security gateways, cloud security gateways, and load balancers with virtual private network (VPN) termination, to name just a few.

Note that while existing systems provide secure protocols and MKTME technology working together, these systems experience performance degradation because packet payloads need to be copied and encrypted/decrypted multiple times.

In embodiments of the present specification, a memory controller such as a TME controller or MKTME controller allows the server to configure memory controller bypass decryption when data in memory is read by a network controller such as a network interface card (NIC). When a first host sends data to a second host, the first host can copy the already encrypted data from its memory directly to the second host memory via RDMA. Because the in-transit data is already encrypted, the network transmission is inherently protected, and the second host can read data from its memory because the two hosts share an encryption key. This encryption key can be provisioned in both the first host and the second host.

Note that in some embodiments, the first host is required to flush the packet to DRAM before issuing the descriptor to the network controller. Any such flushes should be fenced. The memory controller is configured to bypass decryption in these RIMA access operations.

Advantageously, the teachings of the present specification enable secure network communications with no memory copies from the application to the protocol stack. The system also requires no additional data decryption in the memory controller or data encryption in the protocol stack. The encryption key may be secured by providing it within a protected enclave of a trusted execution environment (TEE), thus avoiding snooping by hypervisors, other VMs, or other virtual network functions (VNFs).

A system and method for providing transparent encryption will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

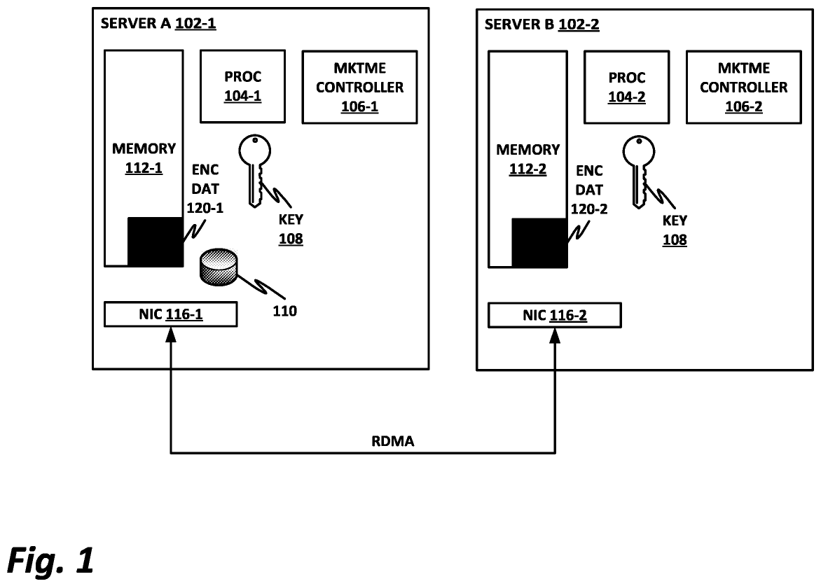

FIG. 1 is a block diagram of a secure communication, according to one or more examples of the present specification. In the example of FIG. 1, server A 102-1 and server B 102-2 are provisioned with a common encryption key 108.

Encryption key 108 may be provisioned, for example, by a TEE enclave within a memory controller such as MKTME controller 106. MKTME controller 106 may be supported by an instruction set such as Intel® Software Guard Extensions (SGX). Both server A 102-1 and server B 102-2 have a respective MKTME controller, namely MKTME controller 106-1 and MKTME controller 106-2. Note that an MKTME controller 106 is provided in this illustration as an example of a memory controller or memory encryption controller that supports the teachings of the present specification. The teachings herein expressly contemplate that MKTME controller 106 could be replaced, by way of nonlimiting example, by a single key total memory encryption controller, by a partial memory encryption controller, or by some other memory encryption controller that supports encryption of at least a portion of a memory such as memory 112.

Each server 102 is also provisioned with a processor 104, namely processor 104-1 for server A 102-1 and processor 104-2 for server B 102-2. Processors 104 may include special instructions such as SGX to support the provisioning of a TEE and/or enclave, and/or memory encryption services. Each server 102 also includes a memory 112, namely memory 112-1 on server A 102-1, and memory 112-2 on server B 102-2. Within memory 112-1 is a region of encrypted data 120-1. Within memory 112-2 is a region of encrypted data 120-2. Encrypted data regions 120-1 and 120-2 may be encrypted via shared key 108, and are therefore decryptable via shared key 108.

Finally, both servers 102 include a NIC 116, namely NIC 116-1 for server A 102-1, and NIC 116-2 for server B 102-2. Note that a NIC 116 may be an Ethernet card, or may support some other fabric, including a data center fabric. For example, NIC 116-1 could be some other network or fabric controller including, by way of nonlimiting example, Intel® silicon photonics, an Intel® Host Fabric Interface (HFI), an intelligent NIC (iNIC), smart NIC, a host channel adapter (HCA) or other host interface, PCI, PCIe, a core-to-core Ultra Path Interconnect (UPI) (formerly called QPI or KTI), Infinity Fabric, Intel® Omni-Path™ Architecture (GPA), TrueScale™, FibreChannel, Ethernet, FibreChannel over Ethernet (FCoE), InfiniBand, a legacy interconnect such as a local area network (LAN), a token ring network, a synchronous optical network (SONET), an asynchronous transfer mode (ATM) network, a wireless network such as Wi-Fi or Bluetooth, a “plain old telephone system” (POTS) interconnect or similar, a multi-drop bus, a mesh interconnect, a point-to-point interconnect, a serial interconnect, a parallel bus, a coherent (e.g., cache coherent) bus, a layered protocol architecture, a differential bus, or a Gunning transceiver logic (GTL) bus, to name just a few. The fabric may be cache- and memory-coherent, cache- and memory-non-coherent, or a hybrid of coherent and non-coherent interconnects. Some interconnects are more popular for certain purposes or functions than others, and selecting an appropriate fabric for the instant application is an exercise of ordinary skill. For example, GPA and Infiniband are commonly used in high-performance computing (HPC) applications, while Ethernet and FibreChannel are more popular in cloud data centers. But these examples are expressly nonlimiting, and as data centers evolve fabric technologies similarly evolve.

As used throughout this specification and claims, a “network controller” is intended to stand for the entire class of devices that may provide an interconnect or fabric between two hosts, including virtual fabrics such as a virtual switch (vSwitch). In some embodiments, NICs 116 may support remote direct memory access (RDMA).

In an illustrative use case, packet data within encrypted data region 120-1 of server A 102-1 is encrypted by MKTME controller 106-1 with encryption key 108. When server A 102-1 needs to send the encrypted packet to server B 102-2, NIC 116-1 may issue an RDMA command. By way of example, encrypted packet 110 is not decrypted and passed to a protocol stack of server A 102-1. Rather, packet 110 is passed directly to NIC 116-1, where it can be transmitted to NIC 116-2 via a non-encrypted or nonsecured protocol (e.g., HTTP for Ethernet, or any other suitable protocol for some other fabric embodiment).

MKTME controller 106-1 may set a flag or send a signal to NIC 116-1, or to software components of server A 102-1 indicating that packet 110 is not to pass through at least an encryption portion of a software protocol stack within server A 102-1. This ensures that packet 110 is not decrypted and then re-encrypted at NIC 116-1, and then decrypted and re-encrypted at NIC 116-2. Rather, NIC 116-1 issues an RDMA command, which places packet 110 directly into encrypted data region 120-2 of memory 112-2. When an application in server B 102-2 accesses encrypted packet 110, MKTME controller 106-2 may decrypt the data within packet 110 using shared encryption key 108.

The system disclosed herein realizes advantages over existing methods that may cause packet 110 to be decrypted and then re-encrypted on server A 102-1, and then decrypted at NIC 116-1, and then re-encrypted within MKTME controller 106-2 of server B 102-2. These extra encryption and decryption operations consume compute resources or accelerator resources, and in many cases are unnecessary. Because packet 110 remains encrypted from end-to-end, network security is still maintained. Furthermore, in the case of an MKTME controller 106, if each tenant within the physical infrastructure owns its own separate encryption key, then data are protected from other tenants within the system.

RDMA is disclosed as an example of a protocol that enables the exchange disclosed herein. But this should be noted as a nonlimiting example. For example, in other embodiments, a protocol such as TCP/IP could be used, and packet 110 can simply be issued to NIC 116-1 as a standard payload for an HTTP transaction. NIC 116-1 can then transmit packet 110-1 to NIC 116-2 via a non-encrypted HTTP channel, and NIC 116-2 can treat packet 110 simply as an ordinary payload. Thus, the teachings of the present specification can be practiced in systems that do not support a protocol such as RDMA.

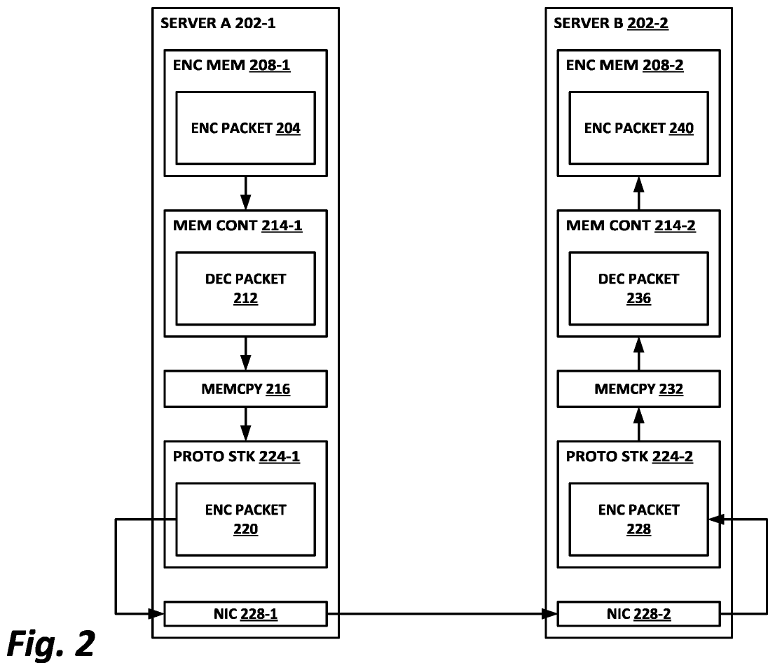

FIG. 2 is a further block diagram of a secure communication, according to one or more examples of the present specification. FIG. 2 illustrates an exchange between a server A 202-1 and a server B 202-2.

In various embodiments, one or both of server A 2024 and server B 202-2 may be provided with a memory controller configured to practice the teachings of the present specification. However, in this example, the two servers 202 engage in a transaction that passes through a protocol stack 224, either because one supports the teachings of the present specification and the other does not, or because circumstances of the transaction dictate that the transaction should occur in this manner.

Server A 202-1 includes encrypted memory 208-1 with an encrypted packet 204, a memory controller 214-1, a memory copy function 216, and a protocol stack 224-1 with a NIC 228-1. Server B 202-2 includes encrypted memory 208-2, a memory controller 214-2, a memory copy function 232, a protocol stack 224-2, and a NIC 228-2.

In this embodiment, because servers 202 do not engage in the teachings of the present specification for this particular transaction, encrypted packet 204 starts within encrypted memory 208-1. Memory controller 214-1 decrypts encrypted packet 204 into decrypted packet 212. Memory copy 216 occurs, so that the decrypted packet 212 is passed to protocol stack 224-1. Protocol stack 224-1 encrypts decrypted packet 212, either in software or by offloading to a hardware accelerator, to provide encrypted packet 220. Encrypted packet 220 is then transmitted via NIC 228-1 over a secure protocol, such as HTTPS, to NIC 228-2. NIC 228-2 then provides encrypted packet 228 to protocol stack 224-2. Protocol stack 224-2 decrypts encrypted packet 228, either in software or via a hardware accelerator. A memory copy 232 then passes newly decrypted packet 236 to memory controller 214-2. Memory controller 214-2 then provides encrypted packet 240 into encrypted memory 208-2.

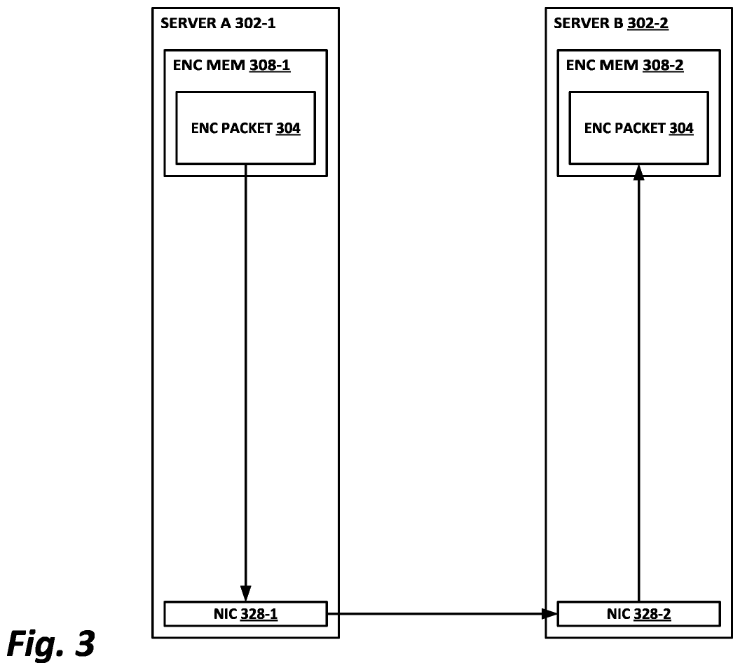

FIG. 3 is a block diagram of an alternative secure communication, according to one or more examples of the present specification. In contrast with the embodiment in FIG. 2, FIG. 3 illustrates an example in which an encrypted packet is passed according to the teachings of the present specification.

In the example of FIG. 3, server A 302-1 includes encrypted memory 308-1 with encrypted packet 304. Server A 302-1 also includes NIC 328-1. Server B 302-2 includes encrypted memory 308-2 and NIC 328-2.

In the illustrated transaction, encrypted packet 304 resides within encrypted memory 308-1. In this example, an appropriate entity such as software or a memory controller passes encrypted packet 304 to NIC 328-1. This bypasses at least an encryption portion of a software protocol stack that may be provided for NIC 328-1. NIC 328-1 then transmits the encrypted packet 304 directly to NIC 328-2, via a nonsecure transaction such as RDMA or HTTP. NIC 328-2 then places encrypted packet 304 directly into encrypted memory 308-2, bypassing at least encryption portions of a software protocol stack. Note that in the case of RDMA, a region of encrypted memory 308-2 may be mapped directly by NIC 328-1, so that encrypted packet 304 can be placed directly into encrypted memory 308-2 in a direct memory access (DMA) fashion, bypassing all or most of a protocol stack.

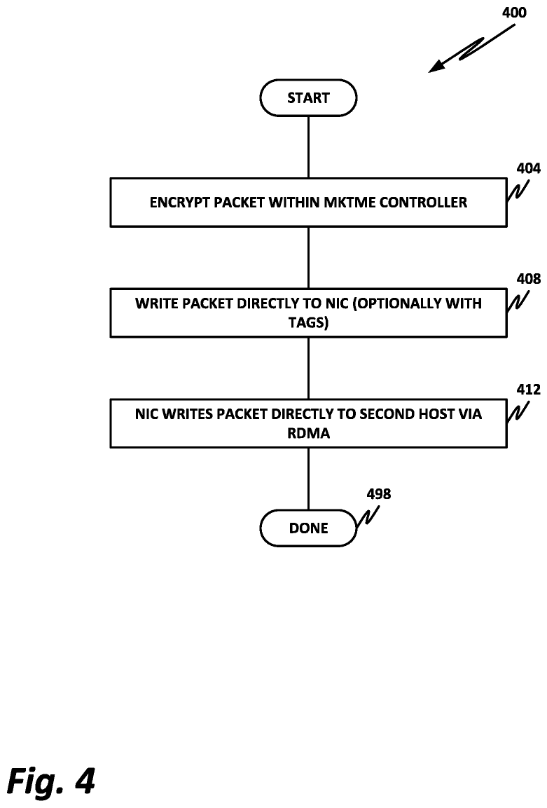

FIG. 4 is a flowchart of a method 400 of transmitting an encrypted packet, according to one or more examples of the present specification.

In block 404, a packet is encrypted, for example within an MKTME controller. Note that the MKTME controller may operate on the unencrypted data of the packet internally, but does not expose the unencrypted packet outside of the MKTME controller.

In block 408, the system writes the packet directly to the NIC. In the case of an RDMA embodiment, RDMA may automatically attempt an encrypted transaction, in which case tags, headers, or other indicators or signals may be required to instruct the RDMA NIC not to encrypt the packet before sending it out. In other examples, the packet may be transmitted using a plain-text protocol such as HTTP over TCP/IP, in which case special flags may not be required, but rather the packet may simply be provided as an ordinary payload.

In block 412, the packet writes the data directly to the second host, such as via RDMA. Alternatively, the data may be written to the second host as an HI IP transaction, or via some other protocol.

In block 498, the method is done.

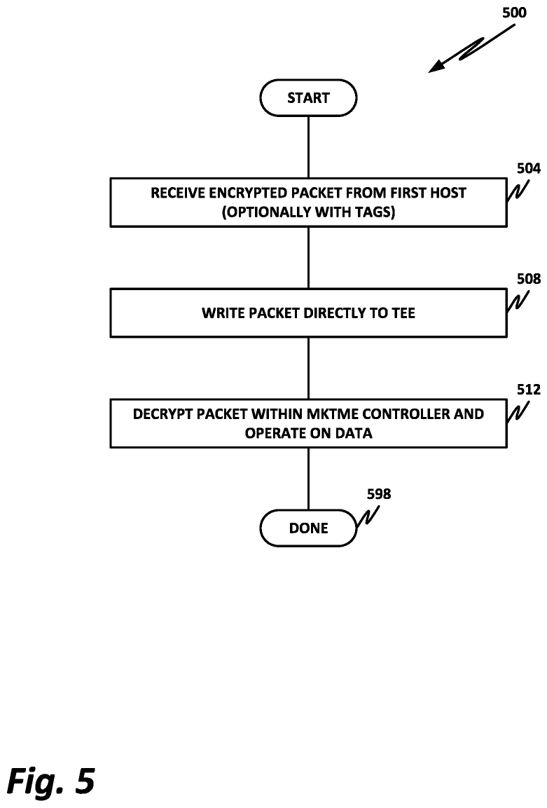

FIG. 5 is a flowchart of a method 500 of receiving an encrypted packet, according to one or more examples of the present specification.

In block 504, the system receives the encrypted packet from the first host. Optionally, this encrypted packet may include tags that indicate that the packet is to be RDMAed directly to an encrypted portion of memory without passing through a decryption portion of a software protocol stack. Alternatively, the packet could be a simple payload within an HTTP or other transaction, and may not require special tags.

In block 508, the NIC writes the data directly to memory, such as within an enclave portion of a TEE, or to some memory address within a total memory encryption system.

In block 512, the MKTME controller decrypts the packet internally, and operates on the data without exposing the data outside of the TEE.

In block 598, the method is done.

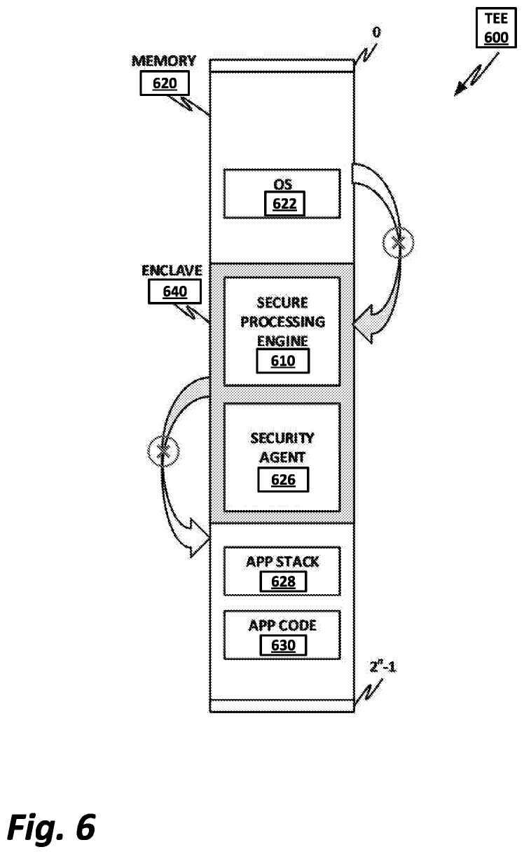

FIG. 6 is a block diagram of a trusted execution environment (TEE), according to one or more examples of the present specification. In the example of FIG. 6, memory 620 is addressable by n-bits, ranging in address from 0 to 2ⁿ-1. Within memory 620 is an OS 622, enclave 640, application stack 628, and application code 630.

In this example, enclave 640 is a specially-designated portion of memory 620 that cannot be entered into or exited from except via special instructions, such as Intel® SGX or similar. Enclave 640 is provided as an example of a secure environment which, in conjunction with a secure processing engine 610, forms a trusted execution environment (TEE) 600 on a client device. A TEE 600 is a combination of hardware, software, and/or memory allocation that provides the ability to securely execute instructions without interference from outside processes, in a verifiable way. By way of example, TEE 600 may include memory enclave 640 or some other protected memory area, and a secure processing engine 610, which includes hardware, software, and instructions for accessing and operating on enclave 640. Nonlimiting examples of solutions that either are or that can provide a TEE include Intel® SGX, ARM TrustZone, AMD Platform Security Processor, Kinibi, securiTEE, OP-TEE, TLK, T6, Open TEE, SierraTEE, CSE, VT-x, MemCore, Canary Island, Docker, and Smack. Thus, it should be noted that in an example, secure processing engine 610 may be a user-mode application that operates within enclave 640. TEE 600 may also conceptually include processor instructions that secure processing engine 610 may utilize to operate within enclave 640.

Secure processing engine 610 may provide a trusted computing base (TCB), which is a set of programs or computational units that are trusted to be secure. Conceptually, it may be advantageous to keep TCB relatively small so that there are fewer attack vectors for malware objects or for negligent software. Thus, for example, operating system 622 may be excluded from TCB, in addition to the regular application stack 628 and application code 630.

In certain systems, computing devices equipped with the Intel® Software Guard Extension (SGX™) or equivalent instructions may be capable of providing an enclave 640. It should be noted however, that many other examples of TEEs are available, and TEE 600 is provided only as one example thereof. Other secure environments may include, by way of nonlimiting example, a virtual machine, sandbox, testbed, test machine, or other similar device or method for providing a TEE 600.

In an example, enclave 640 provides a protected memory area that cannot be accessed or manipulated by ordinary computer instructions. Enclave 640 is described with particular reference to an Intel® SGX™ enclave by way of example, but it is intended that enclave 640 encompass any secure processing area with suitable properties, regardless of whether it is called an “enclave.”

One feature of an enclave is that once an enclave region 640 of memory 620 is defined, as illustrated, a program pointer cannot enter or exit enclave 640 without the use of special enclave instructions or directives, such as those provided by Intel® SGX architecture. For example, SGX processors provide the ENCLU[EENTER], ENCLU[ERESUME], and ENCLU[EEXIT]. These are the only instructions that may legitimately enter into or exit from enclave 640.

Thus, once enclave 640 is defined in memory 620, a program executing within enclave 640 may be safely verified to not operate outside of its bounds. This security feature means that secure processing engine 610 is verifiably local to enclave 640. Thus, when an untrusted packet provides its content to be rendered in enclave 640, the result of the rendering is verified as secure.

Enclave 640 may also digitally sign its output, which provides a verifiable means of ensuring that content has not been tampered with or modified since being rendered by secure processing engine 610. A digital signature provided by enclave 640 is unique to enclave 640 and is unique to the hardware of the device hosting enclave 640.

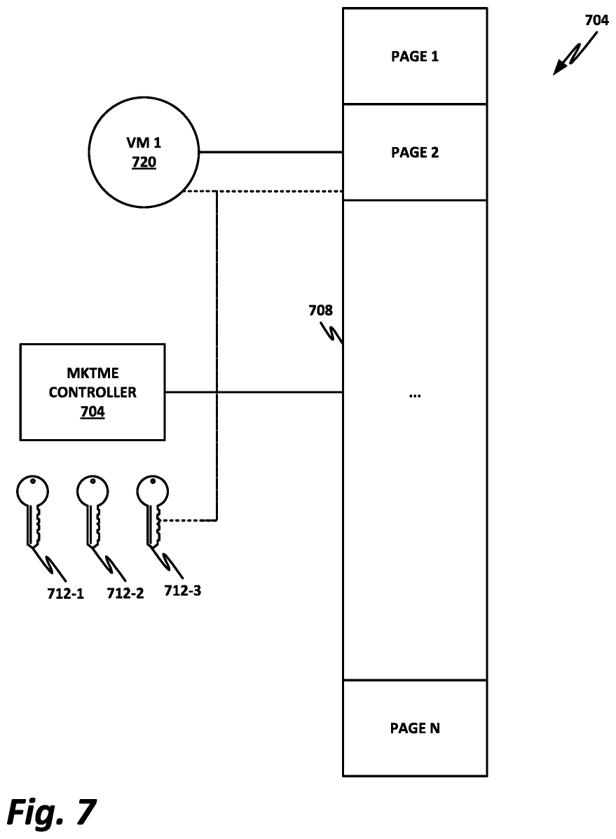

FIG. 7 is a block diagram of a multi-key total memory encryption (MKTME) system 700, according to one or more examples of the present specification. FIG. 7 illustrates an encrypted memory 708, which is subject to total memory encryption.

Memory 708 includes a plurality of pages, namely page 1 through page n, and each memory page may be separately encryptable by its own memory key 712.

MKTME controller 704 may provision a plurality of keys 712, and each key may be “owned” by a specific guest that owns a particular memory page. For example, if VM 1 720 owns page 2 within memory 708, then VM 1 720 may also own encryption key 712-3, which may be used to encrypt page 2. This ensures that VM 1 720 effectively “owns” the contents of page 2 of memory 708, and that other VMs or guests within the same system or hardware platform cannot see the contents of page 2 of memory 708.

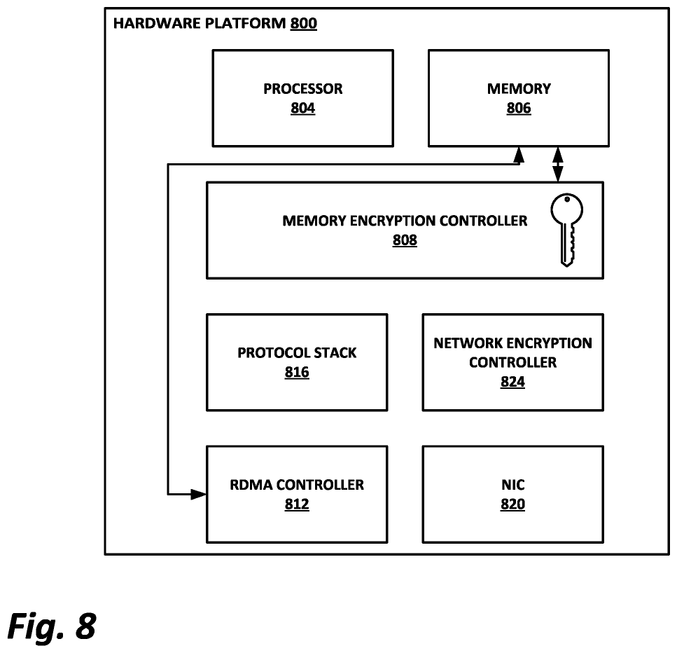

FIG. 8 is a block diagram of a hardware platform 800, according to one or more examples of the present specification. In this embodiment, hardware platform 800 includes a processor 804, a memory 806, a memory encryption controller 808, a protocol stack 816, a network encryption controller 824, an RDMA controller 812, and a NIC 820.

As used in the present specification, processor 804 includes any programmable logic device with an instruction set. Processors may be real or virtualized, local or remote, or in any other configuration. A processor may include, by way of nonlimiting example, an Intel® processor (e.g., Xeon®, Core™, Pentium®, Atom®, Celeron®, x86, or others). A processor may also include competing processors, such as AMD (e.g., Kx-series x86 workalikes, or Athlon, Opteron, or Epyc-series Xeon workalikes), ARM processors, or IBM PowerPC and Power ISA processors, by way of nonlimiting example.

In embodiments of the present disclosure, memory is provided as computer hardware integrated circuits that store information in a digital format, either temporarily or permanently, and which allow for rapid retrieval of that information by way of a hardware platform such as hardware platform 800.

As further disclosed in the present specification, a network interface card (NIC) is a computer hardware component that enables a computer to communicatively connect with a network. A NIC may be used in both wired and wireless computing embodiments, and is provided as an add-in card that fits into an expansion slot of a computer motherboard. NICS are also known, by way of nonlimiting example, as network interface controller cards, network adapter cards, expansion cards, LAN cards, and circuit boards.

In this embodiment, processor 804 may include special instructions such as Intel® SGX or similar, which enable the provisioning of memory encryption controller 808. Memory encryption controller 808 has an encryption key, which is used to encrypt all or a portion of memory 806. RDMA controller 812 may be configured to DMA data directly to or from memory 806, bypassing all or part of protocol stack 816. NIC 820 may provide a physical interface to a remote host, or alternately, a virtual interface to a virtual network.

Absent the teachings of the present specification, a transaction between hardware platform 800 and a remote host may include memory encryption controller 808 decrypting data and passing the data through protocol stack 816, which provides the data to network encryption controller 824. Network encryption controller 824 then provides the encrypted data to NIC 820, and the data can be sent to the remote host.

However, with the teachings of the present specification, memory encryption controller 808 can bypass all or part of protocol stack 816, and operate RDMA controller 812 to remotely DMA the encrypted packet directly to memory of a remote host, thus bypassing protocol stack 816 and network encryption controller 824. As discussed above, this provides advantages both in terms of consumption of compute resources, and in terms of consumption of power, particularly within a data center.

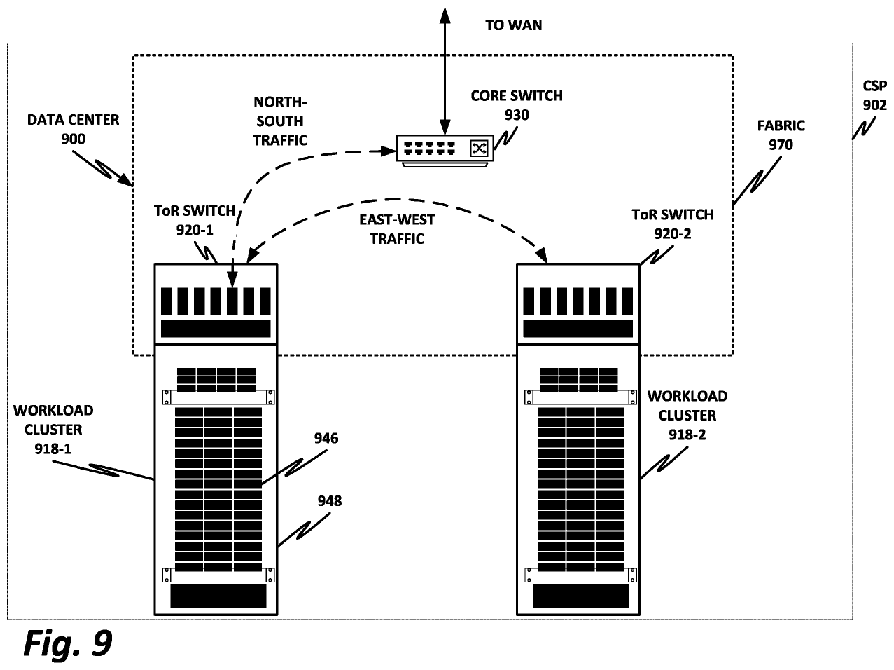

FIG. 9 is a block diagram of selected components of a data center 900 with connectivity to a network of a cloud service provider (CSP) 902, according to one or more examples of the present specification. Embodiments of data center 900 disclosed herein may be adapted or configured to provide the method of transparent encryption according to the teachings of the present specification. CSP 902 may be, by way of nonlimiting example, a traditional enterprise data center, an enterprise “private cloud,” or a “public cloud,” providing services such as infrastructure as a service (IaaS), platform as a service (PaaS), or software as a service (SaaS). In some cases, CSP 902 may provide, instead of or in addition to cloud services, high-performance computing (HPC) platforms or services. Indeed, while not expressly identical, HPC clusters (“supercomputers”) may be structurally similar to cloud data centers, and unless and except where expressly specified, the teachings of this specification may be applied to either.

CSP 902 may provision some number of workload clusters 918, which may be clusters of individual servers, blade servers, rackmount servers, or any other suitable server topology. In this illustrative example, two workload clusters, 918-1 and 918-2 are shown, each providing rackmount servers 946 in a chassis 948.

In this illustration, workload clusters 918 are shown as modular workload clusters conforming to the rack unit (“U”) standard, in which a standard rack, 19 inches wide, may be built to accommodate 42 units (42U), each 1.75 inches high and approximately 36 inches deep. In this case, compute resources such as processors, memory, storage, accelerators, and switches may fit into some multiple of rack units from one to 42.

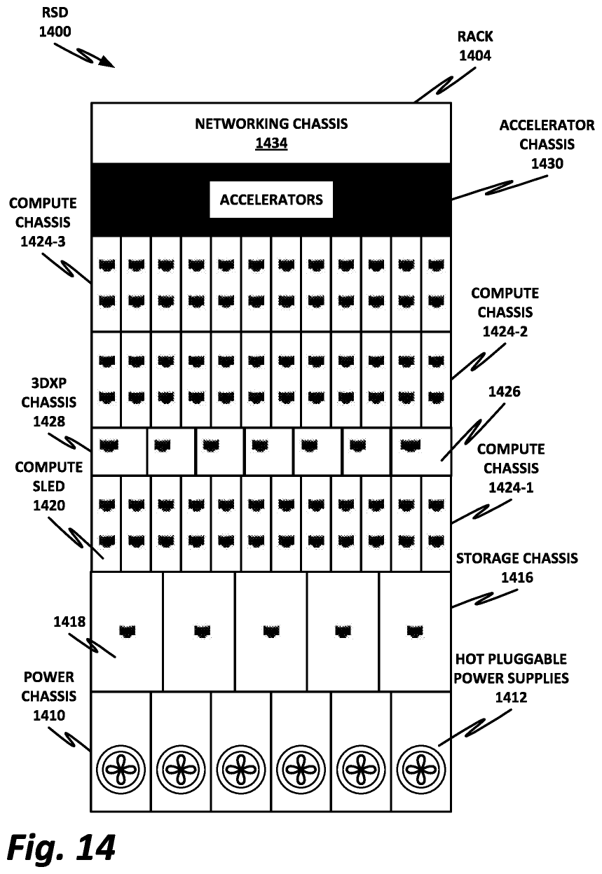

However, other embodiments are also contemplated. For example, FIG. 14 illustrates a resource sled. While the resource sled may be built according to standard rack units (e.g., a 3U resource sled), it is not necessary to do so in a so-called “rackscale” architecture. In that case, entire pre-populated racks of resources may be provided as a unit, with the rack hosting a plurality of compute sleds, which may or may not conform to the rack unit standard (particularly in height). In those cases, the compute sleds may be considered “line replaceable units” (LRUs). If a resource fails, the sled hosting that resource can be pulled, and a new sled can be modularly inserted. The failed sled can then be repaired or discarded, depending on the nature of the failure. Rackscale design is particularly useful in the case of software-defined infrastructure (SDI), wherein composite nodes may be built from disaggregated resources. Large resource pools can be provided, and an SDI orchestrator may allocate them to composite nodes as necessary.

Each server 946 may host a standalone operating system and provide a server function, or servers may be virtualized, in which case they may be under the control of a virtual machine manager (VMM), hypervisor, and/or orchestrator, and may host one or more virtual machines, virtual servers, or virtual appliances. These server racks may be collocated in a single data center, or may be located in different geographic data centers. Depending on the contractual agreements, some servers 946 may be specifically dedicated to certain enterprise clients or tenants, while others may be shared.

The various devices in a data center may be connected to each other via a switching fabric 970, which may include one or more high speed routing and/or switching devices. Switching fabric 970 may provide both “north-south” traffic (e.g., traffic to and from the wide area network (WAN), such as the Internet), and “east-west” traffic (e.g., traffic across the data center). Historically, north-south traffic accounted for the bulk of network traffic, but as web services become more complex and distributed, the volume of east-west traffic has risen. In many data centers, east-west traffic now accounts for the majority of traffic.

Furthermore, as the capability of each server 946 increases, traffic volume may further increase. For example, each server 946 may provide multiple processor slots, with each slot accommodating a processor having four to eight cores, along with sufficient memory for the cores. Thus, each server may host a number of VMs, each generating its own traffic.

To accommodate the large volume of traffic in a data center, a highly capable switching fabric 970 may be provided. Switching fabric 970 is illustrated in this example as a “flat” network, wherein each server 946 may have a direct connection to a top-of-rack (ToR) switch 920 (e.g., a “star” configuration), and each ToR switch 920 may couple to a core switch 930. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 946 may include an Intel® Host Fabric Interface (HFI), a NIC, a host channel adapter (HCA), or other host interface. For simplicity and unity, these may be referred to throughout this specification as a “host fabric interface” (HFI), which should be broadly construed as an interface to communicatively couple the host to the data center fabric. The HFI may couple to one or more host processors via an interconnect or bus, such as PCI, PCIe, or similar. In some cases, this interconnect bus, along with other “local” interconnects (e.g., core-to-core Ultra Path Interconnect) may be considered to be part of fabric 970. In other embodiments, the UPI (or other local coherent interconnect) may be treated as part of the secure domain of the processor complex, and thus not part of the fabric.

The interconnect technology may be provided by a single interconnect or a hybrid interconnect, such as where PCIe provides on-chip communication, 1 Gb or 10 Gb copper Ethernet provides relatively short connections to a ToR switch 920, and optical cabling provides relatively longer connections to core switch 930. Interconnect technologies that may be found in the data center include, by way of nonlimiting example, Intel® Omni-Path™ Architecture (OPA), TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few. The fabric may be cache- and memory-coherent, cache- and memory-non-coherent, or a hybrid of coherent and non-coherent interconnects. Some interconnects are more popular for certain purposes or functions than others, and selecting an appropriate fabric for the instant application is an exercise of ordinary skill. For example, OPA and Infiniband are commonly used in high-performance computing (HPC) applications, while Ethernet and FibreChannel are more popular in cloud data centers. But these examples are expressly nonlimiting, and as data centers evolve fabric technologies similarly evolve.

Note that while high-end fabrics such as OPA are provided herein by way of illustration, more generally, fabric 970 may be any suitable interconnect or bus for the particular application. This could, in some cases, include legacy interconnects like local area networks (LANs), token ring networks, synchronous optical networks (SONET), ATM networks, wireless networks such as Wi-Fi and Bluetooth, “plain old telephone system” (POTS) interconnects, or similar. It is also expressly anticipated that in the future, new network technologies may arise to supplement or replace some of those listed here, and any such future network topologies and technologies can be or form a part of fabric 970.

In certain embodiments, fabric 970 may provide communication services on various “layers,” as originally outlined in the Open Systems Interconnection (OSI) seven-layer network model. In contemporary practice, the OSI model is not followed strictly. In general terms, layers 1 and 2 are often called the “Ethernet” layer (though in some data centers or supercomputers, Ethernet may be supplanted or supplemented by newer technologies). Layers 3 and 4 are often referred to as the transmission control protocol/Internet protocol (TCP/IP) layer (which may be further subdivided into TCP and IP layers). Layers 5-7 may be referred to as the “application layer.” These layer definitions are disclosed as a useful framework, but are intended to be nonlimiting.

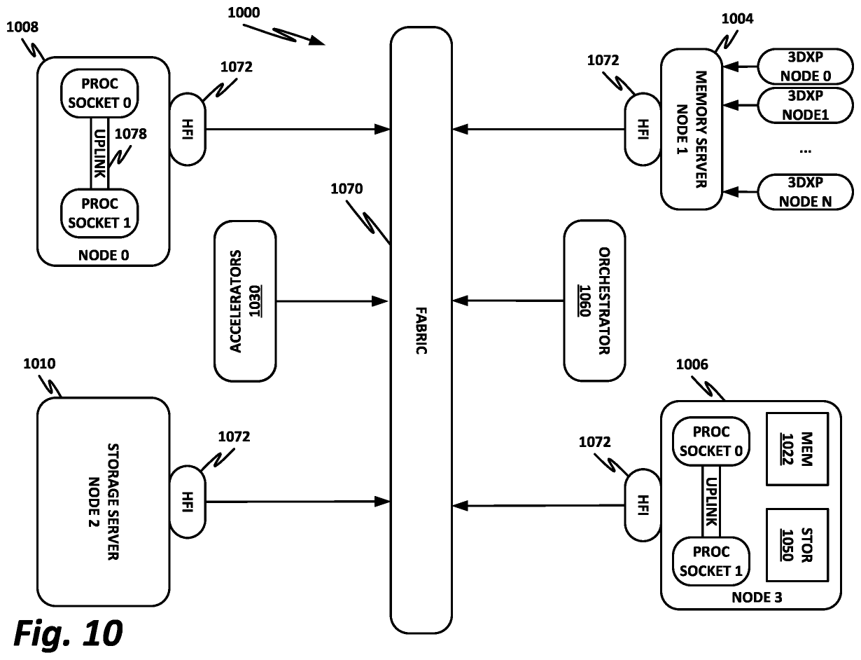

FIG. 10 is a block diagram of an end-user computing device 1000, according to one or more examples of the present specification. Embodiments of computing device 1000 disclosed herein may be adapted or configured to provide the method of transparent encryption according to the teachings of the present specification.

As above, computing device 1000 may provide, as appropriate, cloud service, high-performance computing, telecommunication services, enterprise data center services, or any other compute services that benefit from a computing device 1000.

In this example, a fabric 1070 is provided to interconnect various aspects of computing device 1000. Fabric 1070 may be the same as fabric 970 of FIG. 9, or may be a different fabric. As above, fabric 1070 may be provided by any suitable interconnect technology. In this example, Intel® Omni-Path™ is used as an illustrative and nonlimiting example.

As illustrated, computing device 1000 includes a number of logic elements forming a plurality of nodes. It should be understood that each node may be provided by a physical server, a group of servers, or other hardware. Each server may be running one or more virtual machines as appropriate to its application.

Node 0 1008 is a processing node including a processor socket 0 and processor socket 1. The processors may be, for example, Intel® Xeon™ processors with a plurality of cores, such as 4 or 8 cores. Node 0 1008 may be configured to provide network or workload functions, such as by hosting a plurality of virtual machines or virtual appliances.

Onboard communication between processor socket 0 and processor socket 1 may be provided by an onboard uplink 1078. This may provide a very high speed, short-length interconnect between the two processor sockets, so that virtual machines running on node 0 1008 can communicate with one another at very high speeds. To facilitate this communication, a virtual switch (vSwitch) may be provisioned on node 0 1008, which may be considered to be part of fabric 1070.

Node 0 1008 connects to fabric 1070 via an HFI 1072. HFI 1072 may connect to an Intel® Omni-Path™ fabric. In some examples, communication with fabric 1070 may be tunneled, such as by providing UPI tunneling over Omni-Path™.

Because computing device 1000 may provide many functions in a distributed fashion that in previous generations were provided onboard, a highly capable HFI 1072 may be provided. HFI 1072 may operate at speeds of multiple gigabits per second, and in some cases may be tightly coupled with node 0 1008. For example, in some embodiments, the logic for HFI 1072 is integrated directly with the processors on a system-on-a-chip. This provides very high speed communication between HFI 1072 and the processor sockets, without the need for intermediary bus devices, which may introduce additional latency into the fabric. However, this is not to imply that embodiments where HFI 1072 is provided over a traditional bus are to be excluded. Rather, it is expressly anticipated that in some examples, HFI 1072 may be provided on a bus, such as a PCIe bus, which is a serialized version of PCI that provides higher speeds than traditional PCI. Throughout computing device 1000, various nodes may provide different types of HFIs 1072, such as onboard HFIs and plug-in HFIs. It should also be noted that certain blocks in a system-on-a-chip may be provided as intellectual property (IP) blocks that can be “dropped” into an integrated circuit as a modular unit. Thus, HFI 1072 may in some cases be derived from such an IP block.

Note that in “the network is the device” fashion, node 0 1008 may provide limited or no onboard memory or storage. Rather, node 0 1008 may rely primarily on distributed services, such as a memory server and a networked storage server. Onboard, node 0 1008 may provide only sufficient memory and storage to bootstrap the device and get it communicating with fabric 1070. This kind of distributed architecture is possible because of the very high speeds of contemporary data centers, and may be advantageous because there is no need to over-provision resources for each node. Rather, a large pool of high speed or specialized memory may be dynamically provisioned between a number of nodes, so that each node has access to a large pool of resources, but those resources do not sit idle when that particular node does not need them.

In this example, a node 1 memory server 1004 and a node 2 storage server 1010 provide the operational memory and storage capabilities of node 0 1008. For example, memory server node 1 1004 may provide remote direct memory access (RDMA), whereby node 0 1008 may access memory resources on node 1 1004 via fabric 1070 in a direct memory access fashion, similar to how it would access its own onboard memory. The memory provided by memory server 1004 may be traditional memory, such as double data rate type 3 (DDR3) dynamic random access memory (DRAM), which is volatile, or may be a more exotic type of memory, such as a persistent fast memory (PFM) like Intel® 3D Crosspoint™ (3DXP), which operates at DRAM-like speeds, but is nonvolatile.

Similarly, rather than providing an onboard hard disk for node 0 1008, a storage server node 2 1010 may be provided. Storage server 1010 may provide a networked bunch of disks (NBOD), PFM, redundant array of independent disks (RAID), redundant array of independent nodes (RAIN), network attached storage (NAS), optical storage, tape drives, or other nonvolatile memory solutions.

Thus, in performing its designated function, node 0 1008 may access memory from memory server 1004 and store results on storage provided by storage server 1010. Each of these devices couples to fabric 1070 via a HFI 1072, which provides fast communication that makes these technologies possible.

By way of further illustration, node 3 1006 is also depicted. Node 3 1006 also includes a HFI 1072, along with two processor sockets internally connected by an uplink. However, unlike node 0 1008, node 3 1006 includes its own onboard memory 1022 and storage 1050. Thus, node 3 1006 may be configured to perform its functions primarily onboard, and may not be required to rely upon memory server 1004 and storage server 1010. However, in appropriate circumstances, node 3 1006 may supplement its own onboard memory 1022 and storage 1050 with distributed resources similar to node 0 1008.

Computing device 1000 may also include accelerators 1030. These may provide various accelerated functions, including hardware or co-processor acceleration for functions such as packet processing, encryption, decryption, compression, decompression, network security, or other accelerated functions in the data center. In some examples, accelerators 1030 may include deep learning accelerators that may be directly attached to one or more cores in nodes such as node 0 1008 or node 3 1006. Examples of such accelerators can include, by way of nonlimiting example, Intel® QuickData Technology (QDT), Intel® QuickAssist Technology (QAT), Intel® Direct Cache Access (DCA), Intel® Extended Message Signaled Interrupt (MSI-X), Intel® Receive Side Coalescing (RSC), and other acceleration technologies.

In other embodiments, an accelerator could also be provided as an application-specific integrated circuit (ASIC), FPGA, co-processor, graphics processing unit (GPU), digital signal processor (DSP), or other processing entity, which may optionally be tuned or configured to provide the accelerator function.

The basic building block of the various components disclosed herein may be referred to as “logic elements.” Logic elements may include hardware (including, for example, a software-programmable processor, an ASIC, or an FPGA), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, non-transitory computer-readable medium having stored thereon executable instructions for instructing a processor to perform a certain task. Such a non-transitory medium could include, for example, a hard disk, solid state memory or disk, read-only memory (ROM), PFM (e.g., Intel® 3D Crosspoint™), external storage, RAID, RAIN, NAS, optical storage, tape drive, backup system, cloud storage, or any combination of the foregoing by way of nonlimiting example. Such a medium could also include instructions programmed into an FPGA, or encoded in hardware on an ASIC or processor.

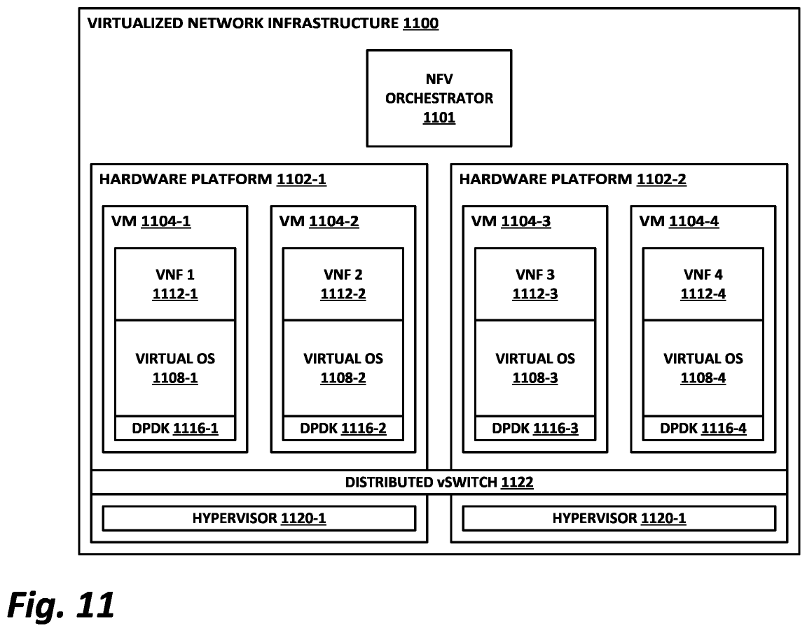

FIG. 11 is a block diagram of a network function virtualization (NFV) infrastructure 1100 according to one or more examples of the present specification. Embodiments of NFV infrastructure 1100 disclosed herein may be adapted or configured to provide the method of transparent encryption according to the teachings of the present specification.

NFV is an aspect of network virtualization that is generally considered distinct from, but that can still interoperate with a software defined network (SDN). For example, virtual network functions (VNFs) may operate within the data plane of an SDN deployment. NFV was originally envisioned as a method for providing reduced capital expenditure (Capex) and operating expenses (Opex) for telecommunication services. One feature of NFU is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancer VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 400. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

Like SDN, NFV is a subset of network virtualization. In other words, certain portions of the network may rely on SDN, while other portions (or the same portions) may rely on NFV.

In the example of FIG. 11, an NFV orchestrator 1101 manages a number of the VNFs 1112 running on an NFVI 1100. NFV requires nontrivial resource management, such as allocating a very large pool of compute resources among appropriate numbers of instances of each VNF, managing connections between UNFs, determining how many instances of each VNF to allocate, and managing memory, storage, and network connections. This may require complex software management, thus making NFV orchestrator 1101 a valuable system resource. Note that NFV orchestrator 1101 may provide a browser-based or graphical configuration interface, and in some embodiments may be integrated with SDN orchestration functions.

Note that NFV orchestrator 1101 itself may be virtualized (rather than a special-purpose hardware appliance). NFV orchestrator 1101 may be integrated within an existing SDN system, wherein an operations support system (OSS) manages the SDN. This may interact with cloud resource management systems (e.g., OpenStack) to provide NFV orchestration. An NFVI 1100 may include the hardware, software, and other infrastructure to enable VNFs to run. This may include a hardware platform 1102 on which one or more VMs 1104 may run. For example, hardware platform 1102-1 in this example runs VMs 1104-1 and 1104-2. Hardware platform 1102-2 runs VMs 1104-3 and 1104-4. Each hardware platform may include a hypervisor 1120, virtual machine manager (VMM), or similar function, which may include and run on a native (bare metal) operating system, which may be minimal so as to consume very few resources.

Hardware platforms 1102 may be or comprise a rack or several racks of blade or slot servers (including, e.g., processors, memory, and storage), one or more data centers, other hardware resources distributed across one or more geographic locations, hardware switches, or network interfaces. An NFVI 1100 may also include the software architecture that enables hypervisors to run and be managed by NFV orchestrator 1101.

Running on NFVI 1100 are a number of VMs 1104, each of which in this example is a VNF providing a virtual service appliance. Each VM 1104 in this example includes an instance of the Data Plane Development Kit (DPDK), a virtual operating system 1108, and an application providing the VNF 1112.

Virtualized network functions could include, as nonlimiting and illustrative examples, firewalls, intrusion detection systems, load balancers, routers, session border controllers, DPI services, network address translation (NAT) modules, or call security association.

The illustration of FIG. 11 shows that a number of VNFs 1104 have been provisioned and exist within NFVI 1100. This figure does not necessarily illustrate any relationship between the VNFs and the larger network, or the packet flows that NFVI 1100 may employ.

The illustrated DPDK instances 1116 provide a set of highly-optimized libraries for communicating across a virtual switch (vSwitch) 1122. Like VMs 1104, vSwitch 1122 is provisioned and allocated by a hypervisor 1120. The hypervisor uses a network interface to connect the hardware platform to the data center fabric (e.g., an HFI). This HFI may be shared by all VMs 1104 running on a hardware platform 1102. Thus, a vSwitch may be allocated to switch traffic between VMs 1104. The vSwitch may be a pure software vSwitch (e.g., a shared memory vSwitch), which may be optimized so that data are not moved between memory locations, but rather, the data may stay in one place, and pointers may be passed between VMs 1104 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1122 is illustrated, wherein vSwitch 1122 is shared between two or more physical hardware platforms 1102.

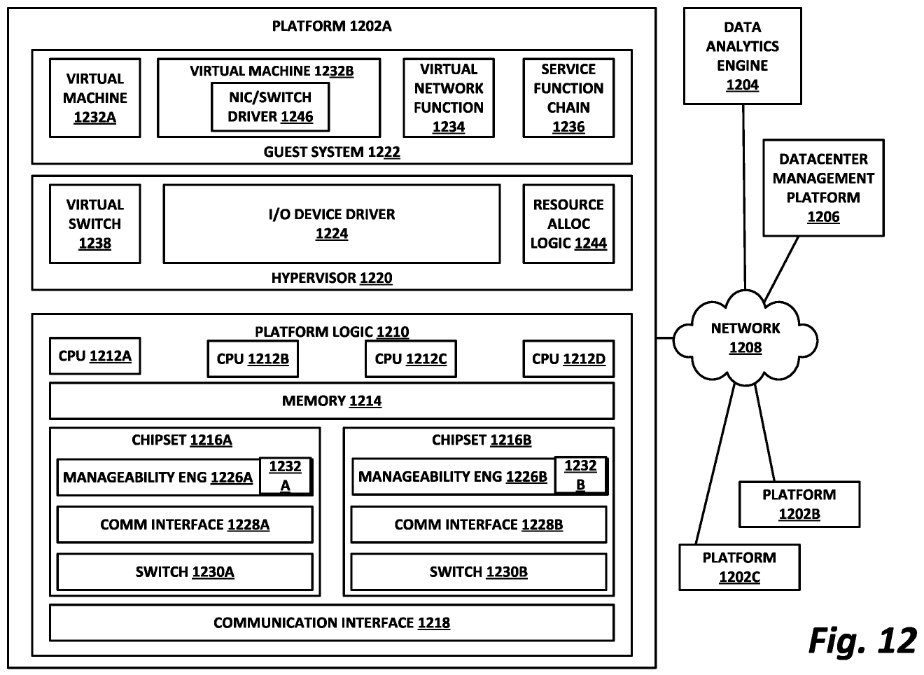

FIG. 12 is a block diagram of components of a computing platform 1202A according to one or more examples of the present specification. Embodiments of computing platform 1202A disclosed herein may be adapted or configured to provide the method of transparent encryption according to the teachings of the present specification.

In the embodiment depicted, hardware platforms 1202A, 12026, and 1202C, along with a data center management platform 1206 and data analytics engine 1204 are interconnected via network 1208. In other embodiments, a computer system may include any suitable number of (i.e., one or more) platforms, including hardware, software, firmware, and other components. In some embodiments (e.g., when a computer system only includes a single platform), all or a portion of the system management platform 1206 may be included on a platform 1202. A platform 1202 may include platform logic 1210 with one or more central processing units (CPUs) 1212, memories 1214 (which may include any number of different modules), chipsets 1216, communication interfaces 1218, and any other suitable hardware and/or software to execute a hypervisor 1220 or other operating system capable of executing workloads associated with applications running on platform 1202. In some embodiments, a platform 1202 may function as a host platform for one or more guest systems 1222 that invoke these applications. Platform 1202A may represent any suitable computing environment, such as a high-performance computing environment, a data center, a communications service provider infrastructure (e.g., one or more portions of an Evolved Packet Core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 1206, hypervisor 1220, or other operating system) of computer platform 1202A may assign hardware resources of platform logic 1210 to perform workloads in accordance with the stress information. In some embodiments, self-diagnostic capabilities may be combined with the stress monitoring to more accurately determine the health of the hardware resources. Each platform 1202 may include platform logic 1210. Platform logic 1210 comprises, among other logic enabling the functionality of platform 1202, one or more CPUs 1212, memory 1214, one or more chipsets 1216, and communication interfaces 1228. Although three platforms are illustrated, computer platform 1202A may be interconnected with any suitable number of platforms. In various embodiments, a platform 1202 may reside on a circuit board that is installed in a chassis, rack, or other suitable structure that comprises multiple platforms coupled together through network 1208 (which may comprise, e.g., a rack or backplane switch).

CPUs 1212 may each comprise any suitable number of processor cores and supporting logic (e.g., uncores). The cores may be coupled to each other, to memory 1214, to at least one chipset 1216, and/or to a communication interface 1218, through one or more controllers residing on CPU 1212 and/or chipset 1216. In particular embodiments, a CPU 1212 is embodied within a socket that is permanently or removably coupled to platform 1202A. Although four CPUs are shown, a platform 1202 may include any suitable number of CPUs.

Memory 1214 may comprise any form of volatile or nonvolatile memory including, without limitation, magnetic media (e.g., one or more tape drives), optical media, random access memory (RAM), read-only memory (ROM), flash memory, removable media, or any other suitable local or remote memory component or components. Memory 1214 may be used for short, medium, and/or long term storage by platform 1202A. Memory 1214 may store any suitable data or information utilized by platform logic 1210, including software embedded in a computer-readable medium, and/or encoded logic incorporated in hardware or otherwise stored (e.g., firmware). Memory 1214 may store data that is used by cores of CPUs 1212. In some embodiments, memory 1214 may also comprise storage for instructions that may be executed by the cores of CPUs 1212 or other processing elements (e.g., logic resident on chipsets 1216) to provide functionality associated with the manageability engine 1226 or other components of platform logic 1210. A platform 1202 may also include one or more chipsets 1216 comprising any suitable logic to support the operation of the CPUs 1212. In various embodiments, chipset 1216 may reside on the same die or package as a CPU 1212 or on one or more different dies or packages. Each chipset may support any suitable number of CPUs 1212. A chipset 1216 may also include one or more controllers to couple other components of platform logic 1210 (e.g., communication interface 1218 or memory 1214) to one or more CPUs. In the embodiment depicted, each chipset 1216 also includes a manageability engine 1226. Manageability engine 1226 may include any suitable logic to support the operation of chipset 1216. In a particular embodiment, a manageability engine 1226 (which may also be referred to as an innovation engine) is capable of collecting real-time telemetry data from the chipset 1216, the CPU(s) 1212 and/or memory 1214 managed by the chipset 1216, other components of platform logic 1210, and/or various connections between components of platform logic 1210. In various embodiments, the telemetry data collected includes the stress information described herein.

In various embodiments, a manageability engine 1226 operates as an out-of-band asynchronous compute agent which is capable of interfacing with the various elements of platform logic 1210 to collect telemetry data with no or minimal disruption to running processes on CPUs 1212. For example, manageability engine 1226 may comprise a dedicated processing element (e.g., a processor, controller, or other logic) on chipset 1216, which provides the functionality of manageability engine 1226 (e.g., by executing software instructions), thus conserving processing cycles of CPUs 1212 for operations associated with the workloads performed by the platform logic 1210. Moreover the dedicated logic for the manageability engine 1226 may operate asynchronously with respect to the CPUs 1212 and may gather at least some of the telemetry data without increasing the load on the CPUs.

A manageability engine 1226 may process telemetry data it collects (specific examples of the processing of stress information are provided herein). In various embodiments, manageability engine 1226 reports the data it collects and/or the results of its processing to other elements in the computer system, such as one or more hypervisors 1220 or other operating systems and/or system management software (which may run on any suitable logic such as system management platform 1206). In particular embodiments, a critical event such as a core that has accumulated an excessive amount of stress may be reported prior to the normal interval for reporting telemetry data (e.g., a notification may be sent immediately upon detection).

Additionally, manageability engine 1226 may include programmable code configurable to set which CPU(s) 1212 a particular chipset 1216 manages and/or which telemetry data may be collected.

Chipsets 1216 also each include a communication interface 1228. Communication interface 1228 may be used for the communication of signaling and/or data between chipset 1216 and one or more I/O devices, one or more networks 1208, and/or one or more devices coupled to network 1208 (e.g., system management platform 1206). For example, communication interface 1228 may be used to send and receive network traffic such as data packets. In a particular embodiment, a communication interface 1228 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 1216 (e.g., manageability engine 1226 or switch 1230) and another device coupled to network 1208. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 1228 may allow communication of data (e.g., between the manageability engine 1226 and the data center management platform 1206) associated with management and monitoring functions performed by manageability engine 1226. In various embodiments, manageability engine 1226 may utilize elements (e.g., one or more NICs) of communication interfaces 1228 to report the telemetry data (e.g., to system management platform 1206) in order to reserve usage of NICs of communication interface 1218 for operations associated with workloads performed by platform logic 1210.

Switches 1230 may couple to various ports (e.g., provided by NICs) of communication interface 1228 and may switch data between these ports and various components of chipset 1216 (e.g., one or more Peripheral Component Interconnect Express (PCIe) lanes coupled to CPUs 1212). Switches 1230 may be a physical or virtual (i.e., software) switch.

Platform logic 1210 may include an additional communication interface 1218. Similar to communication interfaces 1228, communication interfaces 1218 may be used for the communication of signaling and/or data between platform logic 1210 and one or more networks 1208 and one or more devices coupled to the network 1208. For example, communication interface 1218 may be used to send and receive network traffic such as data packets. In a particular embodiment, communication interfaces 1218 comprise one or more physical NICs. These NICs may enable communication between any suitable element of platform logic 1210 (e.g., CPUs 1212 or memory 1214) and another device coupled to network 1208 (e.g., elements of other platforms or remote computing devices coupled to network 1208 through one or more networks).

Platform logic 1210 may receive and perform any suitable types of workloads. A workload may include any request to utilize one or more resources of platform logic 1210, such as one or more cores or associated logic. For example, a workload may comprise a request to instantiate a software component, such as an I/O device driver 1224 or guest system 1222; a request to process a network packet received from a virtual machine 1232 or device external to platform 1202A (such as a network node coupled to network 1208); a request to execute a process or thread associated with a guest system 1222, an application running on platform 1202A, a hypervisor 1220 or other operating system running on platform 1202A; or other suitable processing request.

A virtual machine 1232 may emulate a computer system with its own dedicated hardware. A virtual machine 1232 may run a guest operating system on top of the hypervisor 1220. The components of platform logic 1210 (e.g., CPUs 1212, memory 1214, chipset 1216, and communication interface 1218) may be virtualized such that it appears to the guest operating system that the virtual machine 1232 has its own dedicated components.

A virtual machine 1232 may include a virtualized NIC (vNIC), which is used by the virtual machine as its network interface. A vNIC may be assigned a media access control (MAC) address or other identifier, thus allowing multiple virtual machines 1232 to be individually addressable in a network.

VNF 1234 may comprise a software implementation of a functional building block with defined interfaces and behavior that can be deployed in a virtualized infrastructure. In particular embodiments, a VNF 1234 may include one or more virtual machines 1232 that collectively provide specific functionalities (e.g., WAN optimization, virtual private network (VPN) termination, firewall operations, load-balancing operations, security functions, etc.). A VNF 1234 running on platform logic 1210 may provide the same functionality as traditional network components implemented through dedicated hardware. For example, a VNF 1234 may include components to perform any suitable NFV workloads, such as virtualized evolved packet core (vEPC) components, mobility management entities, 3rd Generation Partnership Project (3GPP) control and data plane components, etc.

SFC 1236 is a group of VNFs 1234 organized as a chain to perform a series of operations, such as network packet processing operations. Service function chaining may provide the ability to define an ordered list of network services (e.g. firewalls, load balancers) that are stitched together in the network to create a service chain.

A hypervisor 1220 (also known as a virtual machine monitor) may comprise logic to create and run guest systems 1222. The hypervisor 1220 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 1210. Services of hypervisor 1220 may be provided by virtualizing in software or through hardware assisted resources that require minimal software intervention, or both. Multiple instances of a variety of guest operating systems may be managed by the hypervisor 1220. Each platform 1202 may have a separate instantiation of a hypervisor 1220.

Hypervisor 1220 may be a native or bare metal hypervisor that runs directly on platform logic 1210 to control the platform logic and manage the guest operating systems. Alternatively, hypervisor 1220 may be a hosted hypervisor that runs on a host operating system and abstracts the guest operating systems from the host operating system. Hypervisor 1220 may include a virtual switch 1238 that may provide virtual switching and/or routing functions to virtual machines of guest systems 1222. The virtual switch 1238 may comprise a logical switching fabric that couples the vNICs of the virtual machines 1232 to each other, thus creating a virtual network through which virtual machines may communicate with each other.

Virtual switch 1238 may comprise a software element that is executed using components of platform logic 1210. In various embodiments, hypervisor 1220 may be in communication with any suitable entity (e.g., a SDN controller) which may cause hypervisor 1220 to reconfigure the parameters of virtual switch 1238 in response to changing conditions in platform 1202 (e.g., the addition or deletion of virtual machines 1232 or identification of optimizations that may be made to enhance performance of the platform).

Hypervisor 1220 may also include resource allocation logic 1244, which may include logic for determining allocation of platform resources based on the telemetry data (which may include stress information). Resource allocation logic 1244 may also include logic for communicating with various components of platform logic 1210 entities of platform 1202A to implement such optimization, such as components of platform logic 1210.

Any suitable logic may make one or more of these optimization decisions. For example, system management platform 1206; resource allocation logic 1244 of hypervisor 1220 or other operating system; or other logic of computer platform 1202A may be capable of making such decisions. In various embodiments, the system management platform 1206 may receive telemetry data from and manage workload placement across multiple platforms 1202. The system management platform 1206 may communicate with hypervisors 1220 (e.g., in an out-of-band manner) or other operating systems of the various platforms 1202 to implement workload placements directed by the system management platform.

The elements of platform logic 1210 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the computer platform 1202A may be coupled together in any suitable manner such as through one or more networks 1208. A network 1208 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

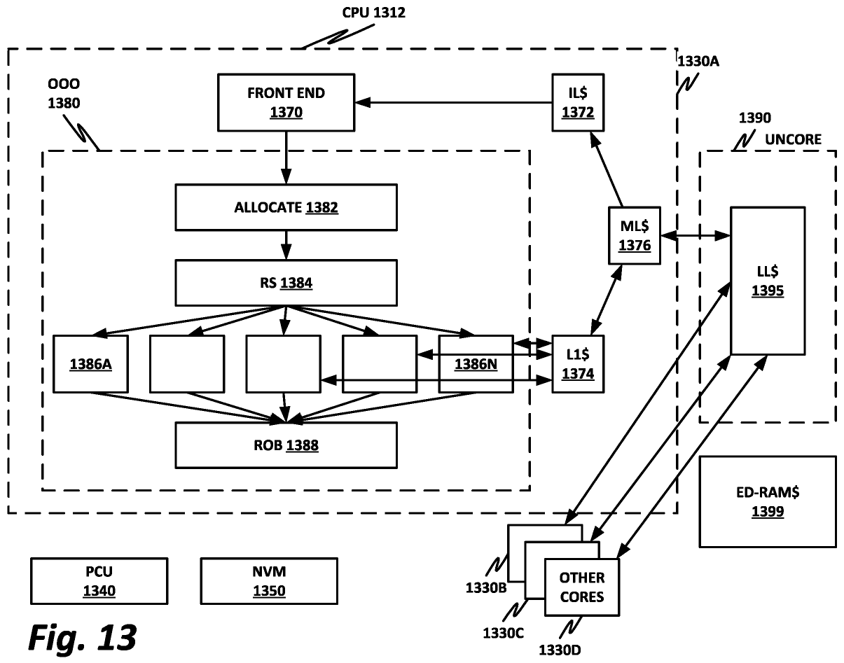

FIG. 13 illustrates a block diagram of a central processing unit (CPU) 1312 in accordance with certain embodiments. Embodiments of CPU 1312 disclosed herein may be adapted or configured to provide the method of transparent encryption according to the teachings of the present specification.

Although CPU 1312 depicts a particular configuration, the cores and other components of CPU 1312 may be arranged in any suitable manner. CPU 1312 may comprise any processor or processing device, such as a microprocessor, an embedded processor, a DSP, a network processor, an application processor, a co-processor, a system-on-a-chip (SoC), or other device to execute code. CPU 1312, in the depicted embodiment, includes four processing elements (cores 1330 in the depicted embodiment), which may include asymmetric processing elements or symmetric processing elements. However, CPU 1312 may include any number of processing elements that may be symmetric or asymmetric.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 1330A includes an out-of-order processor that has a front end unit 1370 used to fetch incoming instructions, perform various processing (e.g. caching, decoding, branch predicting, etc.) and passing instructions/operations along to an out-of-order (OOO) engine. The OOO engine performs further processing on decoded instructions.

A front end 1370 may include a decode module coupled to fetch logic to decode fetched elements. Fetch logic, in one embodiment, includes individual sequencers associated with thread slots of cores 1330. Usually a core 1330 is associated with a first ISA, which defines/specifies instructions executable on core 1330. Often machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. Decoders of cores 1330, in one embodiment, recognize the same ISA (or a subset thereof). Alternatively, in a heterogeneous core environment, a decoder of one or more cores (e.g., core 13306) may recognize a second ISA (either a subset of the first ISA or a distinct ISA).

In the embodiment depicted, the out-of-order engine includes an allocate unit 1382 to receive decoded instructions, which may be in the form of one or more micro-instructions or cops, from front end unit 1370, and allocate them to appropriate resources such as registers and so forth. Next, the instructions are provided to a reservation station 1384, which reserves resources and schedules them for execution on one of a plurality of execution units 1386A-1386N. Various types of execution units may be present, including, for example, arithmetic logic units (ALUs), load and store units, vector processing units (VPUs), floating point execution units, among others. Results from these different execution units are provided to a reorder buffer (ROB) 1388, which take unordered results and return them to correct program order.

In the embodiment depicted, both front end unit 1370 and out-of-order engine 1380 are coupled to different levels of a memory hierarchy. Specifically shown is an instruction level cache 1372, that in turn couples to a mid-level cache 1376, that in turn couples to a last level cache 1395. In one embodiment, last level cache 1395 is implemented in an on-chip (sometimes referred to as uncore) unit 1390. Uncore 1390 may communicate with system memory 1399, which, in the illustrated embodiment, is implemented via embedded DRAM (eDRAM). The various execution units 1386 within OOO engine 1380 are in communication with a first level cache 1374 that also is in communication with mid-level cache 1376. Additional cores 1330B-1330D may couple to last level cache 1395 as well.

In particular embodiments, uncore 1390 may be in a voltage domain and/or a frequency domain that is separate from voltage domains and/or frequency domains of the cores. That is, uncore 1390 may be powered by a supply voltage that is different from the supply voltages used to power the cores and/or may operate at a frequency that is different from the operating frequencies of the cores.

CPU 1312 may also include a power control unit (PCU) 1340. In various embodiments, PCU 1340 may control the supply voltages and the operating frequencies applied to each of the cores (on a per-core basis) and to the uncore. PCU 1340 may also instruct a core or uncore to enter an idle state (where no voltage and clock are supplied) when not performing a workload.

In various embodiments, PCU 1340 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 1340 may detect stress characteristics at any suitable interval.

In various embodiments, PCU 1340 is a component that is discrete from the cores 1330. In particular embodiments, PCU 1340 runs at a clock frequency that is different from the clock frequencies used by cores 1330. In some embodiments where the PCU is a microcontroller, PCU 1340 executes instructions according to an ISA that is different from an ISA used by cores 1330.

In various embodiments, CPU 1312 may also include a nonvolatile memory 1350 to store stress information (such as stress characteristics, incremental stress values, accumulated stress values, stress accumulation rates, or other stress information) associated with cores 1330 or uncore 1390, such that when power is lost, the stress information is maintained.

FIG. 14 is a block diagram of rack scale design 1400 according to one or more examples of the present specification. Embodiments of RSD 1400 disclosed herein may be adapted or configured to provide the method of transparent encryption according to the teachings of the present specification.

In this example, RSD 1400 includes a single rack 1404, to illustrate certain principles of RSD. It should be understood that RSD 1400 may include many such racks, and that the racks need not be identical to one another. In some cases a multipurpose rack such as rack 1404 may be provided, while in other examples, single-purpose racks may be provided. For example, rack 1404 may be considered a highly inclusive rack that includes resources that may be used to allocate a large number of composite nodes. On the other hand, other examples could include a rack dedicated solely to compute sleds, storage sleds, memory sleds, and other resource types, which together can be integrated into composite nodes. Thus, rack 1404 of FIG. 14 should be understood to be a nonlimiting example of a rack that may be used in an RSD 1400.

In the example of FIG. 14, rack 1404 may be a standard rack with an external width of approximately 23.6 inches and a height of 78.74 inches. In common usage, this is referred to as a “42U rack.” However, rack 1404 need not conform to the “rack unit” standard. Rather, rack 1404 may include a number of chassis that are optimized for their purposes.

Rack 1404 may be marketed and sold as a monolithic unit, with a number of line replaceable units (LRUs) within each chassis. The LRUs in this case may be sleds, and thus can be easily swapped out when a replacement needs to be made.

In this example, rack 1404 includes a power chassis 1410, a storage chassis 1416, three compute chassis (1424-1, 1424-2, and 1424-3), a 3-D Crosspoint™ (3DXP) chassis 1428, an accelerator chassis 1430, and a networking chassis 1434. Each chassis may include one or more LRU sleds holding the appropriate resources. For example, power chassis 1410 includes a number of hot pluggable power supplies 1412, which may provide shared power to rack 1404. In other embodiments, some sled chassis may also include their own power supplies, depending on the needs of the embodiment.

Storage chassis 1416 includes a number of storage sleds 1418. Compute chassis 1424 each contain a number of compute sleds 1420. 3DXP chassis 1428 may include a number of 3DXP sleds 1426, each hosting a 3DXP memory server. And accelerator chassis 1430 may host a number of accelerators, such as Intel® Quick Assist™ technology (9T), FPGAs, ASICs, or other accelerators of the same or different types. Accelerators within accelerator chassis 1430 may be the same type or of different types according to the needs of a particular embodiment.

Over time, the various LRUs within rack 1404 may become damaged, outdated, or may experience functional errors. As this happens, LRUs may be pulled and replaced with compatible LRUs, thus allowing the rack to continue full scale operation.

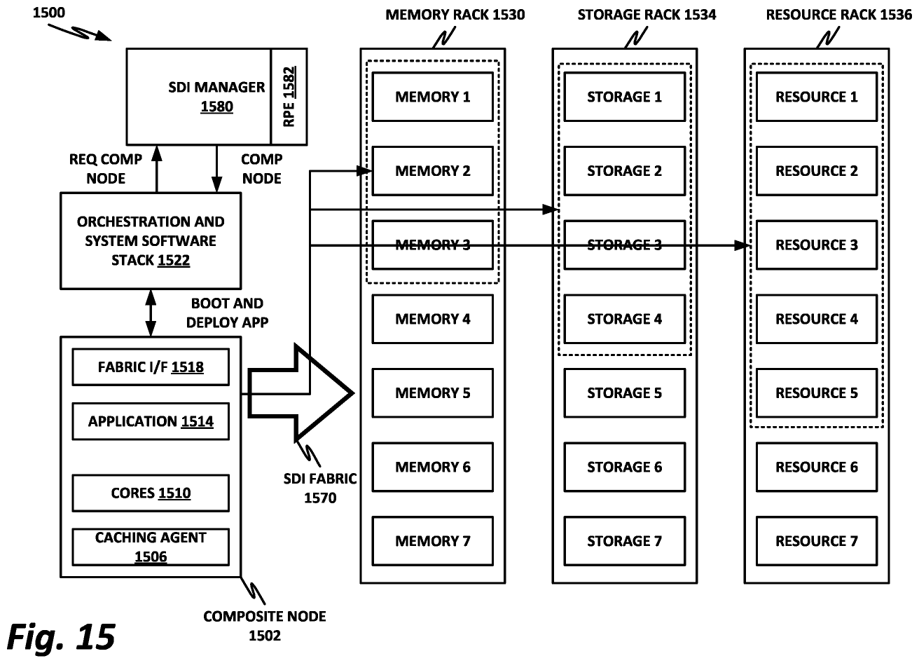

FIG. 15 is a block diagram of a software-defined infrastructure (SDI) data center 1500, according to one or more examples of the present specification. Embodiments of SDI data center 1500 disclosed herein may be adapted or configured to provide the method of transparent encryption according to the teachings of the present specification.

Certain applications hosted within SDI data center 1500 may employ a set of resources to achieve their designated purposes, such as processing database queries, serving web pages, or providing computer intelligence.

Certain applications tend to be sensitive to a particular subset of resources. For example, SAP HANA is an in-memory, column-oriented relational database system. A SAP HANA database may use processors, memory, disk, and fabric, while being most sensitive to memory and processors. In one embodiment, composite node 1502 includes one or more cores 1510 that perform the processing function. Node 1502 may also include caching agents 1506 that provide access to high speed cache. One or more applications 1514 run on node 1502, and communicate with the SDI fabric via HFI 1518. Dynamically provisioning resources to node 1502 may include selecting a set of resources and ensuring that the quantities and qualities provided meet required performance indicators, such as service level agreements (SLAB) and quality of service (QoS). Resource selection and allocation for application 1514 may be performed by a resource manager, which may be implemented within orchestration and system software stack 1522. By way of nonlimiting example, throughout this specification the resource manager may be treated as though it can be implemented separately or by an orchestrator. Note that many different configurations are possible.

In an SDI data center, applications may be executed by a composite node such as node 1502 that is dynamically allocated by SDI manager 1580. Such nodes are referred to as composite nodes because they are not nodes where all of the resources are necessarily collocated. Rather, they may include resources that are distributed in different parts of the data center, dynamically allocated, and virtualized to the specific application 1514.

In this example, memory resources from three memory sleds from memory rack 1530 are allocated to node 1502, storage resources from four storage sleds from storage rack 1534 are allocated, and additional resources from five resource sleds from resource rack 1536 are allocated to application 1514 running on composite node 1502. All of these resources may be associated to a particular compute sled and aggregated to create the composite node. Once the composite node is created, the operating system may be booted in node 1502, and the application may start running using the aggregated resources as if they were physically collocated resources. As described above, HFI 1518 may provide certain interfaces that enable this operation to occur seamlessly with respect to node 1502.

As a general proposition, the more memory and compute resources that are added to a database processor, the better throughput it can achieve. However, this is not necessarily true for the disk or fabric. Adding more disk and fabric bandwidth may not necessarily increase the performance of the SAP HANA database beyond a certain threshold.

SDI data center 1500 may address the scaling of resources by mapping an appropriate amount of offboard resources to the application based on application requirements provided by a user or network administrator or directly by the application itself. This may include allocating resources from various resource racks, such as memory rack 1530, storage rack 1534, and resource rack 1536.

In an example, SDI controller 1580 also includes a resource protection engine (RPE) 1582, which is configured to assign permission for various target resources to disaggregated compute resources (DRCs) that are permitted to access them. In this example, the resources are expected to be enforced by an HFI servicing the target resource.

In certain embodiments, elements of SDI data center 1500 may be adapted or configured to operate with the disaggregated telemetry model of the present specification.

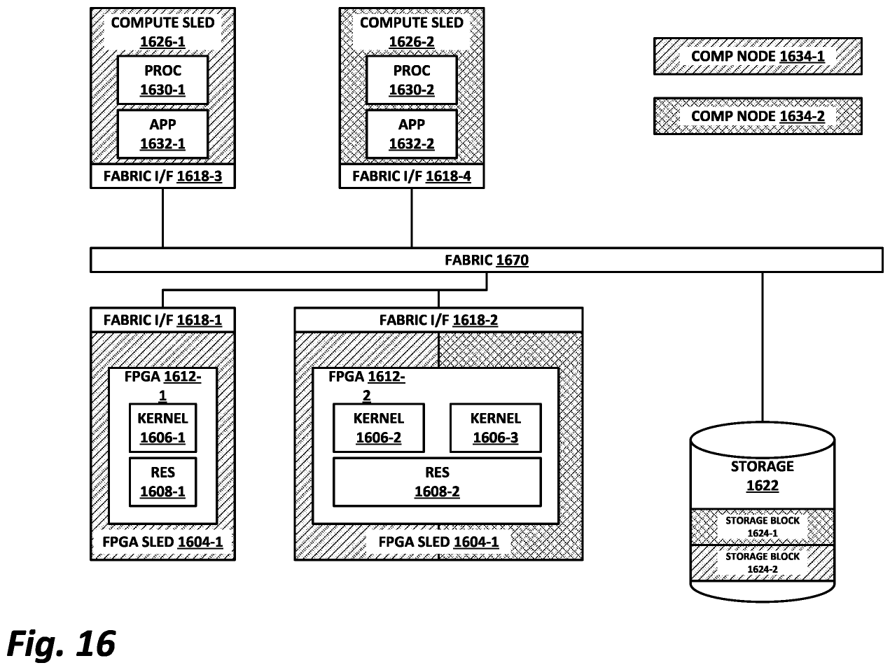

FIG. 16 is a block diagram of a data center 1600, according to one or more examples of the present specification. Embodiments of data center 1600 disclosed herein may be adapted or configured to provide the method of transparent encryption according to the teachings of the present specification.

In the example of FIG. 16, two composite nodes, namely composite node 1634-1 and composite node 1634-2 are defined.

Data center 1600 includes a number of resources that may be disaggregated and that may be defined as part of a composite node according to the teachings of the present specification. For example, compute sleds 1626-1 and 1626-2 each include a processor, respectively 1630-1 and 1630-2. Each processor 1630 may host a respective application, 1632-1 and 1632-2.

Note that in various embodiments, compute sleds 1626-1 may also provide local memory, storage, accelerators, or other resources for processor 1630-1. However, in accordance with the SDI teachings of the present specification, certain resources assigned to composite nodes 1634 may also be disaggregated, or physically remote from processors 1630. In this example, each composite node 1634 has assigned to it one or more FPGAs 1612 residing in FPGA sleds 1604. These FPGAs may provide an accelerated function operating at near hardware speeds, and provided by a kernel 1606. Each FPGA 1612 may also have access to certain local FPGA resources 1608. Composite node 1634 may also have access to storage blocks 1624 within storage sled 1622. Storage 1622 may also be a disaggregated resource provided in a resource sled.

It should be noted that, for simplicity and clarity of the illustration, only selected components are disclosed in this illustration. However, other disaggregated resources may also be provided. For example, data center 1600 may include a memory server providing disaggregated memory, including persistent fast memory, which composite nodes 1634 may access via remote direct memory access (RDMA).

In this example, composite node 1634-1 includes processor 1630-1 on compute sled 1626-1, running application 1632-1, and accessing fabric 1670 via HFI 1618-3. Composite node 1634-1 also includes FPGA 1612-1 running on FPGA sled 1604-1, running FPGA kernel 1606-1, and having access to FPGA resources 1608-1. FPGA sled 1604-1 may access fabric 1670 via HFI 1618-1. Note that in this example, a plurality of FPGAs on FPGA sled 1604-1 may be connected to one another via a passive backplane, and a single HFI 1618-1 may be provided for the entire sled. Composite node 1634-1 may also have access to storage block 1624-1 on storage sled 1622. Within FPGA sled 1604-2, FPGA 1612-2 has access to a shared resource 1608-2, which is accessed by two different kernels, kernel 1606-2 and kernel 1606-3. Kernel 1606-2 on FPGA 1612-1 is also assigned to composite node 1634-1, while kernel 1606-3 is not.

Composite node 1634-2 includes processor 1630-2 running application 1632-2 on compute sled 1626-2. Compute sled 1626-2 connects to fabric 1670 via HFI 1618-4. Note that compute sleds 1626 may also include a number of processors, memory, and other local resources that may be communicatively coupled to one another via a passive backplane, and share a common HFI 1618. Composite node 1634-2 also includes kernel 1606-3 running on shared FPGA 1612-2, and having access to shared resource 1608-2. Composite node 1634-2 may store data on storage block 1624-2.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present specification.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

In the foregoing description, certain aspects of some or all embodiments are described in greater detail than is strictly necessary for practicing the appended claims. These details are provided by way of nonlimiting example only, for the purpose of providing context and illustration of the disclosed embodiments. Such details should not be understood to be required, and should not be “read into” the claims as limitations. The phrase may refer to “an embodiment” or “embodiments.” These phrases, and any other references to embodiments, should be understood broadly to refer to any combination of one or more embodiments. Furthermore, the several features disclosed in a particular “embodiment” could just as well be spread across multiple embodiments. For example, if features 1 and 2 are disclosed in “an embodiment,” embodiment A may have feature 1 but lack feature 2, while embodiment B may have feature 2 but lack feature 1.

This specification may provide illustrations in a block diagram format, wherein certain features are disclosed in separate blocks. These should be understood broadly to disclose how various features interoperate, but are not intended to imply that those features must necessarily be embodied in separate hardware or software. Furthermore, where a single block discloses more than one feature in the same block, those features need not necessarily be embodied in the same hardware and/or software. For example, a computer “memory” could in some circumstances be distributed or mapped between multiple levels of cache or local memory, main memory, battery-backed volatile memory, and various forms of persistent memory such as a hard disk, storage server, optical disk, tape drive, or similar. In certain embodiments, some of the components may be omitted or consolidated. In a general sense, the arrangements depicted in the figures may be more logical in their representations, whereas a physical architecture may include various permutations, combinations, and/or hybrids of these elements. Countless possible design configurations can be used to achieve the operational objectives outlined herein. Accordingly, the associated infrastructure has a myriad of substitute arrangements, design choices, device possibilities, hardware configurations, software implementations, and equipment options.

References may be made herein to a computer-readable medium, which may be a tangible and non-transitory computer-readable medium. As used in this specification and throughout the claims, a “computer-readable medium” should be understood to include one or more computer-readable mediums of the same or different types. A computer-readable medium may include, by way of nonlimiting example, an optical drive (e.g., CD/DVD/Blu-Ray), a hard drive, a solid state drive, a flash memory, or other nonvolatile medium. A computer-readable medium could also include a medium such as a read-only memory (ROM), an FPGA or ASIC configured to carry out the desired instructions, stored instructions for programming an FPGA or ASIC to carry out the desired instructions, an intellectual property (IP) block that can be integrated in hardware into other circuits, or instructions encoded directly into hardware or microcode on a processor such as a microprocessor, DSP, microcontroller, or in any other suitable component, device, element, or object where appropriate and based on particular needs. A non-transitory storage medium herein is expressly intended to include any non-transitory special-purpose or programmable hardware configured to provide the disclosed operations, or to cause a processor to perform the disclosed operations.

Various elements may be “communicatively,” “electrically,” “mechanically,” or otherwise “coupled” to one another throughout this specification and the claims. Such coupling may be a direct, point-to-point coupling, or may include intermediary devices. For example, two devices may be communicatively coupled to one another via a controller that facilitates the communication. Devices may be electrically coupled to one another via intermediary devices such as signal boosters, voltage dividers, or buffers. Mechanically coupled devices may be indirectly mechanically coupled.

Any “module” or “engine” disclosed herein may refer to or include software, a software stack, a combination of hardware, firmware, and/or software, a circuit configured to carry out the function of the engine or module, or any computer-readable medium as disclosed above. Such modules or engines may, in appropriate circumstances, be provided on or in conjunction with a hardware platform, which may include hardware compute resources such as a processor, memory, storage, interconnects, networks and network interfaces, accelerators, or other suitable hardware. Such a hardware platform may be provided as a single monolithic device (e.g., in a PC form factor), or with some or part of the function being distributed (e.g., a “composite node” in a high-end data center, where compute, memory, storage, and other resources may be dynamically allocated and need not be local to one another).

There may be disclosed herein flow charts, signal flow diagram, or other illustrations showing operations being performed in a particular order. Unless otherwise expressly noted, or unless required in a particular context, the order should be understood to be a nonlimiting example only. Furthermore, in cases where one operation is shown to follow another, other intervening operations may also occur, which may be related or unrelated. Some operations may also be performed simultaneously or in parallel. In cases where an operation is said to be “based on” or “according to” another item or operation, this should be understood to imply that the operation is based at least partly on or according at least partly to the other item or operation. This should not be construed to imply that the operation is based solely or exclusively on, or solely or exclusively according to the item or operation.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

In a general sense, any suitably-configured circuit or processor can execute any type of instructions associated with the data to achieve the operations detailed herein. Any processor disclosed herein could transform an element or an article (for example, data) from one state or thing to another state or thing. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms “memory” and “storage,” as appropriate.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a computing apparatus, comprising: a memory; a memory encryption controller to encrypt at least a region of the memory; and a network interface to communicatively couple the computing apparatus to a remote host; wherein the memory encryption controller is configured to send an encrypted packet decryptable via an encryption key directly from the memory to the remote host via the network interface, bypassing a network protocol stack.

Example 2 includes the computing apparatus of example 1, wherein the apparatus is further to receive an encrypted packet directly into the memory via the network interface, bypassing the network protocol stack.

Example 3 includes the computing apparatus of example 1, wherein the network interface is configured to put the encrypted packet directly to memory of the remote host via remote direct memory access (RDMA).

Example 4 includes the computing apparatus of example 1, wherein the encryption key is a shared key between the apparatus and the remote host.

Example 5 includes the computing apparatus of example 1, wherein the apparatus is configured to perform a key exchange with the remote host to create a shared key.

Example 6 includes the computing apparatus of example 1, wherein the memory encryption controller is configured to store the key.

Example 7 includes the computing apparatus of example 1, wherein the memory encryption controller is configured to provide the apparatus with a trusted execution environment (TEE).

Example 8 includes the computing apparatus of example 1, wherein the memory encryption controller is configured to sign the encrypted packet.

Example 9 includes the computing apparatus of example 1, wherein the memory encryption controller is configured to instruct the network controller to send the encrypted packet using a plain-text transfer protocol.

Example 10 includes the computing apparatus of example 1, wherein the memory encryption controller is a hardware memory encryption controller.

Example 11 includes the computing apparatus of example 1, wherein the memory encryption controller is a total memory encryption controller.

Example 12 includes the hardware apparatus of example 1, wherein the memory encryption controller is a multi-key total memory encryption controller.

Example 13 includes a memory controller comprising: an interface to communicatively couple to and encrypt at least part of a memory according to an encryption key; an interface to communicatively couple to a network controller; and non-transitory instructions to send an encrypted packet directly from an encrypted portion of the memory to a remote host via the network controller without an intermediate encryption.

Example 14 includes the memory controller of example 13, wherein the memory controller is further to receive an encrypted packet directly into the memory via the network controller without an intermediate encryption.

Example 15 includes the memory controller of example 13, wherein the memory controller is configured to instruct the network controller to put the encrypted packet directly to memory of the remote host via remote direct memory access (RDMA).

Example 16 includes the memory controller of example 13, wherein the encryption key is a shared key with the remote host.

Example 17 includes the memory controller of example 13, wherein the memory controller is configured to cause a key exchange to be performed with the remote host to create a shared key.

Example 18 includes the memory controller of example 13, further comprising an encrypted internal memory to store the encryption key.

Example 20 includes the memory controller of example 13, wherein the non-transitory instructions are further configured to provision a trusted execution environment (TEE).

Example 21 includes the memory controller of example 13, wherein the non-transitory instructions are further configured to sign the encrypted packet.

Example 22 includes the memory controller of example 13, wherein the non-transitory instructions are further configured to instruct the network controller to send the encrypted packet using a plain-text transfer protocol.

Example 23 includes the memory controller of example 13, wherein the memory encryption controller is a hardware memory encryption controller.

Example 24 includes the memory controller of example 13, wherein the memory encryption controller is a total memory encryption controller.

Example 25 includes the memory controller of example 13, wherein the memory encryption controller is a multi-key total memory encryption controller.

Example 26 includes the memory controller of any of examples 13-24, wherein the memory controller comprises an application-specific integrated circuit (ASIC).

Example 27 includes the memory controller of any of examples 13-24, wherein the memory controller comprises a field-programmable gate array (FPGA).

Example 28 includes the memory controller of any of examples 13-24, wherein the memory controller comprises a memory and a processor.

Example 29 includes the memory controller of any of examples 13-24, wherein the memory controller comprises a memory and a co-processor.

Example 30 includes the memory controller of any of examples 13-24, wherein the memory controller comprises an intellectual property (IP) block.

Example 31 includes a system-on-a-chip (SoC) comprising the memory controller of any of examples 13-24.

Example 32 includes a method of providing encrypted communication, comprising: communicatively coupling to and encrypting at least part of a memory according to an encryption key; communicatively coupling to a network controller; and sending an encrypted packet directly from an encrypted portion of the memory to a remote host via the network controller without an intermediate encryption.

Example 33 includes the method of example 31, further comprising receiving an encrypted packet directly into the memory via the network controller without an intermediate encryption.

Example 34 includes the method of example 31, further comprising instructing the network controller to put the encrypted packet directly to memory of the remote host via remote direct memory access (RDMA).

Example 35 includes the method of example 31, wherein the encryption key is a shared key with the remote host.

Example 36 includes the method of example 31, further comprising causing a key exchange to be performed with the remote host to create a shared key.

Example 37 includes the method of example 31, further comprising storing the encryption key within an encrypted internal memory of a memory encryption controller.

Example 38 includes the method of example 31, further comprising provisioning a trusted execution environment (TEE).

Example 39 includes the method of example 31, further comprising signing the encrypted packet.

Example 40 includes the method of example 31, further comprising sending the encrypted packet using a plain-text transfer protocol.

Example 41 includes an apparatus comprising means for performing the method of any of examples 31-39.

Example 42 includes the apparatus of example 40, wherein the means comprise a memory encryption controller.

Example 43 includes the apparatus of example 41, wherein the memory encryption controller is a hardware memory encryption controller.

Example 44 includes the apparatus of example 41, wherein the memory encryption controller is a total memory encryption controller.

Example 45 includes the apparatus of example 41, wherein the memory encryption controller is a multi-key total memory encryption controller.

Example 46 includes the apparatus of example 41, wherein the memory encryption controller comprises an application-specific integrated circuit (ASIC).

Example 47 includes the apparatus of example 41, wherein the memory encryption controller comprises a field-programmable gate array (FPGA).

Example 48 includes the apparatus of example 41, wherein the memory encryption controller comprises a memory and a processor.

Example 49 includes the apparatus of example 41, wherein the memory encryption controller comprises a memory and a co-processor.

Example 50 includes the apparatus of example 41, wherein the memory encryption controller comprises an intellectual property (IP) block.

Example 51 includes a system-on-a-chip (SoC) comprising the apparatus of any of examples 40-49.

1-25. (canceled)

26. Integrated circuit for use in association with a computing platform, the integrated circuit being for use in data communication with graphics processing unit hardware and at least one remote computer, the integrated circuit being usable in association with at least one network switch and a management system, the integrated circuit comprising:
remote direct memory access (RDMA) communication hardware for use in the data communication; and
secure network communication accelerator hardware for use in offloading cryptographic operations associated with the data communication;
wherein:
the data communication is to be implemented via accelerator-associated kernel execution;
the data communication comprises Infiniband protocol communication with the at least one remote computer;
the integrated circuit is configurable for use in implementing at least one fabric associated with the at least one network switch;
the integrated circuit is configurable to provide telemetry data to the management system for use in determining resource health-related information associated with the integrated circuit, the management system being for use in association with cloud computing network connection monitoring;
the integrated circuit is configurable for use in association with cloud computing tenant isolation; and
the integrated circuit is for use with a system-on-chip (SOC) comprised in the computing platform, the SOC comprising multiple central processing unit (CPU) cores.

27. The integrated circuit of claim 26, wherein another system-on-chip comprises the integrated circuit.

28. The integrated circuit of claim 27, wherein the integrated circuit is to communicate with the graphics processing unit hardware via at least one Peripheral Component Interconnect Express interconnect.

29. The integrated circuit of claim 28, wherein the integrated circuit is for use in association with virtual machines and/or containers.

30. The integrated circuit of claim 29, wherein:
the integrated circuit comprises a trusted execution environment; and
the computing platform is configurable for use in implementing virtual switch (vSwitch).

31. Non-transitory computer-readable memory storing instructions for being executed by an integrated circuit, the integrated circuit being for use in association with a computing platform, the integrated circuit being for use in data communication with graphics processing unit hardware and at least one remote computer, the integrated circuit being usable in association with at least one network switch and a management system, the integrated circuit including remote direct memory access (RDMA) communication hardware and secure network communication accelerator hardware, the instructions when executed by the integrated circuit resulting in the integrated circuit being configured for performance of operations comprising:
using the RDMA communication hardware in the data communication; and
offloading, using the secure network communication accelerator hardware, cryptographic operations associated with the data communication;
wherein:
the data communication is to be implemented via accelerator-associated kernel execution;
the data communication comprises Infiniband protocol communication with the at least one remote computer;
the integrated circuit is configurable for use in implementing at least one fabric associated with the at least one network switch;
the integrated circuit is configurable to provide telemetry data to the management system for use in determining resource health-related information associated with the integrated circuit, the management system being for use in association with cloud computing network connection monitoring;
the integrated circuit is configurable for use in association with cloud computing tenant isolation; and
the integrated circuit is for use with a system-on-chip (SOC) comprised in the computing platform, the SOC comprising multiple central processing unit (CPU) cores.

32. The non-transitory computer-readable memory of claim 31, wherein another system-on-chip comprises the integrated circuit.

33. The non-transitory computer-readable memory of claim 32, wherein the integrated circuit is to communicate with the graphics processing unit hardware via at least one Peripheral Component Interconnect Express interconnect.

34. The non-transitory computer-readable memory of claim 33, wherein the integrated circuit is for use in association with virtual machines and/or containers.

35. The non-transitory computer-readable memory of claim 34, wherein:
the integrated circuit comprises a trusted execution environment; and
the computing platform is configurable for use in implementing virtual switch (vSwitch).

36. Computing platform for use in association with an integrated circuit, graphics processing unit hardware, at least one remote computer, at least one network switch, and a management system, the computing platform comprising:
at least one system-on-chip (SOC) comprising multiple central processing unit (CPU) cores; and
computer-readable memory storing instructions to be executed by the at least SOC, the instructions, when executed by the at least one SOC, resulting in the computing platform performing operations comprising:
using remote direct memory access (RDMA) communication hardware of the integrated circuit in data communication with the graphics processing unit hardware and the at least one remote computer; and
using secure network communication accelerator hardware of the integrated circuit in offloading cryptographic operations associated with the data communication;
wherein:
the data communication is to be implemented via accelerator-associated kernel execution;
the data communication comprises Infiniband protocol communication with the at least one remote computer;
the integrated circuit is configurable for use in implementing at least one fabric associated with the at least one network switch;
the integrated circuit is configurable to provide telemetry data to the management system for use in determining resource health-related information associated with the integrated circuit, the management system being for use in association with cloud computing network connection monitoring; and
the integrated circuit is configurable for use in association with cloud computing tenant isolation.

37. The computing platform of claim 36, wherein another system-on-chip comprises the integrated circuit.

38. The computing platform of claim 37, wherein the integrated circuit is to communicate with the graphics processing unit hardware via at least one Peripheral Component Interconnect Express interconnect.

39. The computing platform of claim 38, wherein the integrated circuit is for use in association with virtual machines and/or containers.

40. The computing platform of claim 39, wherein:
the integrated circuit comprises a trusted execution environment; and
the computing platform is configurable for use in implementing virtual switch (vSwitch).

41. At least one server system for use in at least one data center, the at least one server system being for use in association with at least one remote computer, the at least one server system comprising:
an integrated circuit;
graphics processing unit hardware;
at least one network switch; and
a management system; and
a computing platform comprising:
at least one system-on-chip (SOC) comprising multiple central processing unit (CPU) cores; and
computer-readable memory storing instructions to be executed by the at least SOC, the instructions, when executed by the at least one SOC, resulting in the computing platform performing operations comprising:
using remote direct memory access (RDMA) communication hardware of the integrated circuit in data communication with the graphics processing unit hardware and the at least one remote computer; and
using secure network communication accelerator hardware of the integrated circuit in offloading cryptographic operations associated with the data communication;
wherein:
the data communication is to be implemented via accelerator-associated kernel execution;
the data communication comprises Infiniband protocol communication with the at least one remote computer;
the integrated circuit is configurable for use in implementing at least one fabric associated with the at least one network switch;
the integrated circuit is configurable to provide telemetry data to the management system for use in determining resource health-related information associated with the integrated circuit;
the management system is for use in association with cloud computing network connection monitoring; and
the integrated circuit is configurable for use in association with cloud computing tenant isolation.

42. The at least one server system of claim 41, wherein another system-on-chip comprises the integrated circuit.

43. The at least one server system of claim 42, wherein the integrated circuit is to communicate with the graphics processing unit hardware via at least one Peripheral Component Interconnect Express interconnect.

44. The at least one server system of claim 43, wherein the integrated circuit is for use in association with virtual machines and/or containers.

45. The at least one server system of claim 44, wherein:
the integrated circuit comprises a trusted execution environment; and
the computing platform is configurable for use in implementing virtual switch (vSwitch).
